(19) United States
(12) Patent Application Publication
(10) Pub. No.: US 2010/0073816 A1
(43) Pub. Date: Mar. 25, 2010

(54) MAGNETIC HEAD AND METHOD OF MANUFACTURING THE SAME, LINEAR TAPE DRIVE APPARATUS, AND MAGNETIC RECORDING AND REPRODUCTION METHOD

(75) Inventors: Yasushi KOMORI, Kanagawa (JP); Shiho Kamisawa, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/566,128

(22) Filed: Sep. 24, 2009

(30) Foreign Application Priority Data
Sep. 25, 2008 (JP) 2008-245620

(51) Int. Cl. G11B 5/127

(52) U.S. Cl. 360/110; 29/603.16; G9B/5.04

(57) ABSTRACT

An aspect of the present invention relates to a magnetic head employed in a linear tape drive in the form of a sliding-contact linear tape drive. The magnetic head comprises multiple indentations that are observed in a surface topographic image viewed by a scanning probe microscope on a surface (sliding contact surface) of sliding contact with a magnetic tape, and the multiple indentations satisfy (1) to (4) below:
(1) an average area of the indentations in the sliding contact surface ranges from about 0.2 μm² to about 1.0 μm²;
(2) a standard deviation of an area of the indentations ranges from about 0.5 μm² to about 2.0 μm²;
(3) an area ratio of the indentations in the sliding contact surface ranges from about 20 percent to about 50 percent; and
(4) an average depth of the indentations is equal to or greater than about 15 nm.

### CROSS-REFERENCE TO RELATED APPLICATIONS

This application claims the benefit of priority under 35 USC 119 to Japanese Patent Application No. 2008-245620, filed on Sep. 25, 2008, which is expressly incorporated herein by reference in its entirety.

### BACKGROUND OF THE INVENTION

1. Field of the Invention

The present invention relates to a magnetic head employed in a linear tape drive in which a magnetic head comes in sliding contact with a magnetic tape during recording and/or reproduction of a magnetic signal, and to a method of manufacturing the same.

The present invention further relates to a linear tape drive comprising the magnetic head, and to a magnetic recording and reproduction method employing the magnetic head.

2. Discussion of the Background

In recent years, substantial development in the means of transmitting information has made possible the transmission of images and data containing huge amounts of information. As part of this process, the recording density of the magnetic recording media used to store such information has continued to increase. Under these conditions, there is a need to reduce the spacing loss when reproducing at a high S/N ratio a signal that has been recorded at high density.

There are floating and sliding contact-type magnetic recording and reproduction systems for recording and reproducing information on magnetic recording media. In hard disk drive systems, which are floating-type systems, the signal is recorded and reproduced without contact between the medium and the head. By contrast, in flexible disk systems and backup tape systems, which are sliding contact-type systems, the head comes in sliding contact with the medium during recording and reproduction. Thus, in sliding contact systems, the head may abrade away due to sliding against the medium. In the investigation of such abrasion of magnetoresistive heads (MR heads) in LTO systems, J. L. Sullivan, Baogui Shi, S. O, Saied, Tribology International 38 (2005) 987-994, which is expressly incorporated herein by reference in its entirety, attribute the abrasion of the Al₂O₃—TiC ceramic (AlTiC) constituting the head to shaving of the Al₂O₃ and TiC for different reasons.

Head abrasion due to contact with the medium can be reduced by increasing the smoothness of the medium surface. Increasing the smoothness of the medium surface is also effective to reduce the spacing loss to enhance recording and reproduction characteristics. However, in sliding contact systems, increasing the smoothness of the medium surface may increase the area of contact between the surface of the medium and the surface of the head, rendering stable running difficult. By contrast, Japanese Unexamined Patent Publication (KOKAI) Heisei No. 8-45015, which is expressly incorporated herein by reference in its entirety, proposes providing regular irregularities on the magnetic head to stabilize running of a magnetic tape of high surface smoothness.

The magnetic recording and reproduction systems that are currently in wide use can be roughly divided into helical scan systems and linear systems. The magnetic head described in Japanese Unexamined Patent Publication (KOKAI) Heisei No. 8-45015 is a magnetic head for use in a helical scan system. Linear systems are known to be superior to helical scan systems in terms of preventing damage to the head and medium. Accordingly, the present inventors investigated the application to a linear system of a magnetic head in which regular irregularities were provided on the sliding contact surface of the magnetic head with the magnetic tape, as proposed in Japanese Unexamined Patent Publication (KOKAI) Heisei No. 8-45015. They found that when the surface of the magnetic tape became extremely smooth, stic-slip occurred during running, making it difficult to achieve stable running.

### SUMMARY OF THE INVENTION

An aspect of the present invention provides for a means of achieving good running stability and electromagnetic characteristics in a linear system comprising a magnetic tape of extremely good surface smoothness.

The present inventors conducted extensive research into achieving the above means, resulting in the discovery that good running stability and electromagnetic characteristics could be achieved in a linear system comprising a magnetic tape of extremely good surface smoothness by means of a magnetic head having prescribed irregular indentations on the surface of sliding contact with the magnetic tape. The present invention was devised on that basis.

An aspect of the present invention relates to a magnetic head employed in a linear tape drive, wherein

the linear tape drive is a sliding-contact linear tape drive in which a magnetic head comes in sliding contact with a magnetic tape during recording and/or reproduction of a magnetic signal,

the magnetic head comprises multiple indentations that are observed in a surface topographic image viewed by a scanning probe microscope on a surface of sliding contact with a magnetic tape, the surface being referred to as “sliding contact surface”, hereinafter, and

the multiple indentations satisfy (1) to (4) below:

(1) an average area of the indentations in the sliding contact surface ranges from about 0.2 μm² to about 1.0 μm²;

(2) a standard deviation of an area of the indentations ranges from about 0.5 μm² to about 2.0 μm²;

(3) an area ratio of the indentations in the sliding contact surface ranges from about 20 percent to about 50 percent; and

(4) an average depth of the indentations is equal to or greater than about 15 nm.

Another aspect of the present invention relates to a linear tape drive apparatus comprising a magnetic tape and a magnetic head, wherein

the linear tape drive apparatus is a sliding-contact linear tape drive apparatus in which a magnetic head comes in sliding contact with a magnetic tape during recording and/or reproduction of a magnetic signal, and

the magnetic head is the above magnetic head.

A further aspect of the present invention relates to a magnetic recording and reproduction method, wherein

a magnetic signal is linearly recorded and/or reproduced on a magnetic tape while a magnetic head comes in sliding contact with the magnetic tape, and

the magnetic head is the above magnetic head.

A still further aspect of the present invention relates to a method of manufacturing the above magnetic head, comprising:

preparing a head chip comprising a recording element and/or a reproduction element between a pair of ceramic films; and

polishing a surface of the ceramic films to form the indentations.

The above magnetic head may comprise two or more protrusions, each protrusion comprising a recording element and/or a reproduction element between a pair of ceramic films, and wherein the sliding contact surface is a top surface of the protrusion.

The above magnetic tape may have a centerline average roughness ranging from about 0.1 nm to about 2.0 nm on a surface on which the magnetic tape comes in sliding contact with a magnetic head during the sliding contact.

The present invention can achieve stable running without a reduction in reproduction output even in a magnetic recording medium with a magnetic layer centerline surface roughness of equal to or lower than 2 nm, for example.

Other exemplary embodiments and advantages of the present invention may be ascertained by reviewing the present disclosure and the accompanying drawings.

### BRIEF DESCRIPTION OF THE DRAWINGS

The present invention will be described in the following text by the exemplary, non-limiting embodiments shown in the figures, wherein:

FIG. 1 is a schematic sectional view of a contour head;

FIG. 2 is a drawing descriptive of the process of fabricating the magnetic head of an aspect of the present invention;

FIG. 3 is a drawing descriptive of the process of fabricating the magnetic head of an aspect of the present invention;

FIG. 4 is a drawing descriptive of the process of fabricating the magnetic head of an aspect of the present invention;

FIG. 5 is a drawing descriptive of the process of fabricating the magnetic head of an aspect of the present invention;

FIG. 6 is a drawing descriptive of the process of fabricating the magnetic head of an aspect of the present invention;

FIG. 7 is a drawing descriptive of the process of fabricating the magnetic head of an aspect of the present invention; and

FIG. 8 is a drawing descriptive of the process of fabricating the magnetic head of an aspect of the present invention.

### DETAILED DESCRIPTION OF THE EMBODIMENTS

Unless otherwise stated, a reference to a compound or component includes the compound or component by itself, as well as in combination with other compounds or components, such as mixtures of compounds.

As used herein, the singular forms “a,” “an,” and “the” include the plural reference unless the context clearly dictates otherwise.

Except where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range. For example, if a range is from about 1 to about 50, it is deemed to include, for example, 1, 7, 34, 46.1, 23.7, or any other value or range within the range.

The following preferred specific embodiments are, therefore, to be construed as merely illustrative, and non-limiting to the remainder of the disclosure in any way whatsoever. In this regard, no attempt is made to show structural details of the present invention in more detail than is necessary for fundamental understanding of the present invention; the description taken with the drawings making apparent to those skilled in the art how several forms of the present invention may be embodied in practice.

### Magnetic Head

An aspect of the present invention relates to a magnetic head for use in a sliding-contact linear tape drive in which a magnetic head comes in sliding contact with a magnetic tape during recording and/or reproduction of a magnetic signal. The magnetic head of the present invention comprises multiple indentations that are observed in a surface topographic image viewed by a scanning probe microscope on a surface of sliding contact with a magnetic tape (referred to as “sliding contact surface”, hereinafter), and the multiple indentations satisfy (1) to (4) below:

(1) an average area of the indentations in the sliding contact surface ranges from about 0.2 μm² to about 1.0 μm²;

(2) a standard deviation of an area of the indentations ranges from about 0.5 μm² to about 2.0 μm²;

(3) an area ratio of the indentations in the sliding contact surface ranges from about 20 percent to about 50 percent; and

(4) an average depth of the indentations is equal to or greater than about 15 nm.

In a sliding contact tape drive in which a magnetic head and magnetic tape come in sliding contact during recording and/or reproduction of a magnetic signal, the smoother the tape surface is made to reduce spacing loss, the more running stability decreases due to an increase in the coefficient of friction. In particular, in linear tape drives in which the area of physical contact between the tape and head is large, in combinations of magnetic tapes of extremely high surface smoothness and conventional magnetic heads, stic-slip occurs during running and it becomes difficult to achieve stable running.

By contrast, in the magnetic head of the present invention, there are multiple irregular indentations that satisfy (1) to (4) above on the sliding contact surface with the magnetic tape. Providing a prescribed quantity of irregular indentations of prescribed size and suitable depth in this manner can prevent stic-slip without compromising recording and reproduction characteristics. Thus, in sliding contact linear tape systems, use in combination with a magnetic tape having an extremely smooth magnetic layer with a centerline average roughness of equal to or lower than 2.0 nm, for example, can achieve both running stability and good recording and reproduction characteristics.

The magnetic head of the present invention will be described in greater detail below.

The magnetic head of the present invention is a magnetic head for use in a sliding contact linear tape drive in which the magnetic head comes in sliding contact with the magnetic tape during recording and/or reproduction of a magnetic signal. In the present invention, the term “linear tape drive” refers to a linear-type tape drive in which a tape is recorded linearly with respect to the running direction of the tape. By contrast, data are recorded with the head inclined at an angle to the running direction of the tape in the helical scan system described in above-cited Japanese Unexamined Patent Publication (KOKAI) Heisei No. 8-45015.

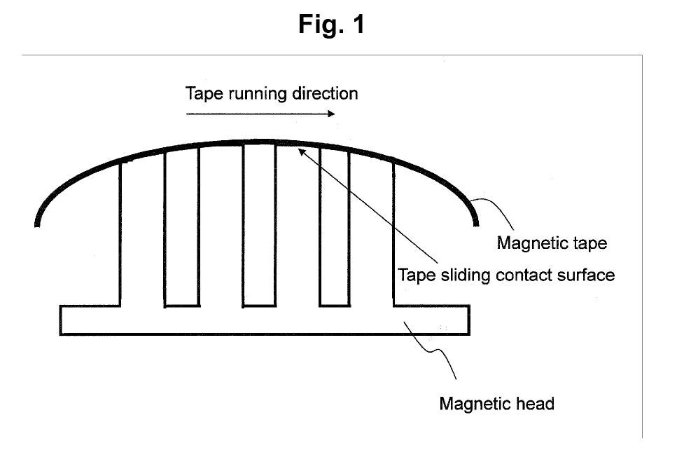

The magnetic heads employed in a linear tape drive come in the form of heads the surface of which is positioned in parallel with the tape running surface, and heads in which two or more protrusions are present, with the top surface of the protrusions serving as a sliding contact surface, as shown in the schematic sectional view of FIG. 1. On the protrusions, a recording element and/or a reproduction element is present between a pair of ceramic films. The former of the above heads is generally called a flat head, and corresponds to the head described in the above-cited J. L. Sullivan, Baogui Shi, S. O, Saied, Tribology International 38 (2005) 987-994, for example. There are known magnetic heads for use in contour linear tape drives (referred to as “contour heads”, hereinafter) that correspond to the latter of the above heads (for example, see Japanese Unexamined Patent Publication (KOKAI) No. 2006-127730, which is expressly incorporated herein by reference in its entirety). In the present invention, the term “contour head” refers to the magnetic head for use in a linear tape drive, having two or more of the above-described protrusions. Contour heads having two or more sets of combinations of a recording element and a reproduction element are known as multichannel magnetic heads.

The magnetic head of the present invention can be either a flat head or a contour head. Compared to flat heads, contour heads can afford a greater contact area with the tape during sliding contact, and are thus normally disadvantageous from the perspective of running stability. By contrast, since the magnetic head of the present invention comprises multiple indentations that satisfy (1) to (4) above on the surface of sliding contact with the magnetic tape, even in the form of a contour head, it is possible to ensure running stability; stable running can be achieved even in magnetic tapes of extremely high surface smoothness. Accordingly, the magnetic head of the present invention is suitable as a contour head.

When the magnetic head of the present invention is a contour head, the number of protrusions is not specifically limited other than it be greater than or equal to two. In the protrusions, a recording element and/or a reproduction element is present between a pair of ceramic films. The elements are desirably magnetoresistive elements (MR elements) from the perspective of enhancing recording and reproduction characteristics. An insulator is normally positioned between the ceramic films and the MR elements. The ceramic films can be formed of AlTiC, Al₂O₃, Al, or the like. From the perspective of facilitating the formation of irregularities on the surface of the ceramic films, they are desirably comprised of AlTiC.

The magnetic head of the present invention comprises multiple indentations that are observed in a surface topographic image by a scanning probe microscope on the surface of sliding contact with the magnetic tape. For example, when the magnetic head of the present invention is a contour head, a portion of the surface of the ceramic films serves as the sliding contact surface. The surface topographic image of a scanning probe microscope can be obtained in the form of an AFM image, for example. The flat portions and the indentations can be readily distinguished by the density of the image in an AFM image. Flat portions and indentations can also be distinguished by image processing software.

Conditions (1) to (4) that are satisfied by the multiple indentations will be described below.

(1) Average Area of the Indentations

The average area of the multiple indentations falls within a range of about 0.2 μm² to about 1.0 μm². It is important to reduce the maximum static frictional force and dynamic frictional force to prevent stic-slip. However, at an average area lower than about 0.2 μm², it is impossible to adequately reduce contact with the tape, and it becomes difficult to reduce the maximum static frictional force and dynamic frictional force. Conversely, when the average area exceeds about 1.0 μm², although the maximum static frictional force decreases, the tape surface cannot be stably supported during tape running. Further, variation in the spacing between the tape and head compromises dynamic frictional force characteristics, making it difficult to obtain good recording and reproduction characteristics. To achieve both running stability and good recording and reproduction characteristics, the average area is desirably about 0.3 μm² to about 0.8 μm², preferably about 0.4 μm² to about 0.6 μm².

(2) Standard Deviation of the Indentation Area

The standard deviation of the area of the indentations in the sliding contact surface falls within a range of about 0.5 μm² to about 2.0 μm². When the standard deviation is less than about 0.5 μm², the size distribution will be narrow, dynamic frictional force characteristics in the width direction of the head will differ from those in the direction of sliding of the head and tape, and a large difference will be produced between the friction when the tape is still and the friction during running, causing great variation in the dynamic frictional force and making it difficult to achieve stable running. Additionally, when the standard deviation exceeds about 2.0 μm², large-area indentations increase. Thus, although the maximum static frictional force drops, the surface of the tape is not stably supported during running, and variation in the spacing between the tape and the head deteriorates dynamic friction characteristics. This makes it difficult to achieve good recording and reproduction characteristics. To achieve both running stability and good recording and reproduction characteristics, the standard deviation is desirably about 0.4 μm² to about 1.8 μm², preferably about 1.0 μm² to about 1.5 μm².

(3) Area Ratio of the Indentation

The area ratio of the indentation in the sliding contact surface (the ratio of the sliding contact surface that is occupied by indentations) falls within a range of about 20 percent to about 50 percent. When the area ratio of the indentation is less than about 20 percent, contact with the tape is not adequately reduced and it becomes difficult to reduce the maximum static frictional force and the dynamic frictional force. Conversely, when the above area ratio exceeds about 50 percent, contact with the tape decreases and the maximum static frictional force diminishes. However, due to the low contact area, the surface of the tape is unsupported, and the spacing between the tape and the head varies during running, resulting in variation of dynamic friction and compromising recording and reproduction characteristics. To achieve both stable running as well as good recording and reproduction characteristics, the area ratio is desirably about 20 percent to about 45 percent, preferably about 25 percent to about 35 percent.

(4) Average Depth of the Indentations

The average depth of the indentations is equal to or greater than about 15 nm. At a depth of less than about 15 nm, the indentations are excessively shallow, some of the indentations end up coming into contact with the tape, there is not an adequate reduction in the tape contact area, and it becomes difficult to achieve an effect in reducing the maximum static frictional force and the dynamic frictional force. The average depth of the indentations is desirably equal to or greater than about 20 nm, preferably equal to or greater than about 25 nm. When the average depth is equal to or greater than about 15 nm, an effect of improved running stability can be achieved. Thus, although the upper limit of the average depth is not specifically limited, an average depth of equal to or lower than about 50 nm can be suitable in terms of workability in the head fabrication process.

The average area, standard deviation, and area ratio of the indentations can be obtained by collection for incline while acquiring an AFM topographic image by a scanning probe microscope, and analyzing the AFM image with image processing software capable of image analysis. Specifically, image processing software in the form of a scanning probe image processor (SPIP: Image Metrology) can be employed. Grain Dialog analysis with the above software permits the calculation of the surface area distribution of the indentations. The average depth of the indentations can be calculated as the difference in peak center value between the peak exhibited by the flat portion (peak 1) and the peak exhibited by the indentations (peak 2) in the AFM topographic image. Reference can be made to Examples described below for details of the measurement method.

The magnetic head of the present invention can be fabricated by running abrasive tape over the head surface serving as the sliding contact surface with the tape during sliding contact to abrade the surface. The head materials and the various conditions during polishing can be adjusted to form indentations that satisfy (1) to (4) above on the sliding contact surface.

Examples of the running conditions of the abrasive tape during polishing are the temperature and humidity during running, the tape running speed, the tape tension, the lapping angle, and the number of times the tape is run back and forth. The temperature of the abrasive tape during running can be about 10° C. to about 40° C., the humidity can be about 10 percent to about 80 percent, the tape running speed can be about 0.1 m/s to about 4 m/s, the tape tension can be about 30 gf to about 200 gf, the lapping angle can be about 1° to about 50°, and the number of times the tape is run back and forth can be about 1 to about 20. The above conditions are desirably set taking into account the composition of the abrasive tape and the magnetic head.

An abrasive tape containing about 0.5 weight parts to about 10 weight parts of abrasive per 100 weight parts of magnetic powder on a nonmagnetic support is desirably employed. The quantity of abrasive is desirably about 3 weight parts to about 8 weight parts, preferably about 4 weight parts to about 6 weight parts, per 100 weight parts of magnetic powder. Examples of desirable abrasives are alumina, diamond, and zirconia. It is also possible to employ an abrasive tape in the form of a magnetic tape from the same lot as the magnetic tape that will be run against the magnetic head of the present invention during recording and reproduction of a magnetic signal.

When an excessively soft tape is employed as the abrasive tape, tape ends up entering the indentations between the ceramic films during polishing of the ceramic film surfaces and thus pole tip recession (PTR) become pronounced. The larger the PTR becomes, the less advantageous it is for high-density recording. Thus, the use of a suitably rigid abrasive tape is desirable. From this perspective, the thickness of the support in the abrasive tape is desirably equal to or greater than about 10 μm, preferably falling within a range of about 15 μm to about 75 μm. The various nonmagnetic supports that can be employed as supports for magnetic tapes, described further below, can be employed as the support of the abrasive tape. Further, when polishing is conducted with an excessively coarse tape, the elements are sometimes damaged during polishing. Thus, to prevent element damage, an abrasive tape with a polishing surface with a surface smoothness in the form of a centerline average roughness of equal to or lower than 4 nm as measured with an HD2000 made by WYKO is desirably employed. From this perspective, the average particle diameter of the abrasive contained in the abrasive tape is desirably equal to or less than about 1 μm, preferably falling within a range of about 0.1 μm to about 0.8 μm.

When the magnetic head of the present invention is a contour head, the ceramic film employed as the head material is desirably ceramic comprised of a TiC phase and an Al₂O₃ phase, that is, AlTiC. AlTiC is capable of forming indentations by the dropping out of TiC particles during polishing. Thus, the average area and average depth of the indentations can be controlled by the size of the TiC particles, and the standard deviation of the indentation area can be controlled by the particle size distribution. Further, the area ratio of the indentations can be controlled by the ratio of TiC to Al₂O₃. An AlTiC film with a TiC/Al₂O₃ weight ratio falling within a range of about 20/80 to about 50/50 is desirably employed as the ceramic film to control the area ratio. It is possible to form indentations at an area ratio of about 20 percent to about 50 percent by polishing AlTiC of the above composition ratio with an abrasive tape to remove the TiC phase and expose the Al₂O₃ phase.

Methods of producing AlTiC that is suitable as the ceramic films will be described below.

The method of producing AlTiC can comprise the steps of selecting starting material powders, dispersing the starting materials, and solidifying the starting materials (hot pressing or the like).

The average area and average depth of the indentations in the sliding contact surface can be kept to within a desired range by selecting the particle size of the constituent starting materials, setting the processing time (in a ball mill or the like) during the dispersing step, and setting the processing time and processing temperature during solidification processing. For example, small indentations can be obtained by a suitable combination of selecting fine particle starting materials, increasing the processing time in the dispersing step, and raising the processing temperature. Since the TiC phase in AlTiC is a discontinuous phase with poor reactivity with continuous alumina matrix phase, the dimensions of the TiC particles in the AlTiC that is finally obtained are normally determined by the dimensions of the TiC particles of the starting materials. To obtain AlTiC suited to forming the above indentations, starting material TiC particles with an average particle diameter of about 0.3 μm to about 1.5 μm are desirably selected. The diameter of the alumina particles is not specifically limited.

The standard deviation (area distribution) of the area of the indentations can be kept to within a desired range by selecting items of desired size from starting materials of various size distribution, setting the processing time by ball mill or the like in the dispersing step, and setting the processing time and the processing temperature during solidification processing. For example, the standard deviation can be reduced (the area distribution can be narrowed) by a suitable combination of selecting starting materials of narrow size distribution and shortening the processing time in the dispersing step. To obtain AlTiC suited to the forming of indentations, starting material TiC particles with a particle diameter standard deviation falling within a range of about 0.05 μm to about 2.0 μm are desirably selected.

Since indentations can be formed by polishing AlTiC, causing TiC particles to drop out, the area ratio of indentations on the sliding contact surface can be controlled by means of the blending ratio of alumina and TiC. To achieve an area ratio of indentations on the sliding contact surface within a range of about 20 percent to about 50 percent, it is desirable to employ AlTiC such that the weight ratio of TiC/Al₂O₃ falls within a range of about 20/80 to about 50/50. Normally, since the starting material composition matches the ceramic film composition, if the starting material blending ratio, as a weight ratio, is made about 30 percent TiC and about 70 percent alumina, for example, it is possible to form an alumina film in which the weight ratio of TiC/Al₂O₃ is about 30/70. By using such alumina film as the above-described ceramic films, it is possible to achieve an area ratio of indentations in the sliding contact surface of about 30 percent.

The magnetic head can be obtained by sandwiching a platelike insulating material, in which an MR element is embedded, between a pair of ceramic sheets to obtain a laminate; cutting the laminate to suitable size to obtain head chips (which will serve as protrusions); and positioning a suitable number of the above head chips on a head carrier. A variety of methods, such as thin-film forming techniques and adhesion techniques, can be combined as desired to form the laminate. The head chips can be bonded to the head carrier with an adhesive, for example.

An example of an MR element is one that is formed by sequentially laminating by sputtering or the like a lower layer in the form of a tantalum layer about 5 nm in thickness, a SAL bias layer in the form of an NiFeNb layer about 32 nm in thickness, an intermediate insulating layer in the form of a tantalum layer about 5 nm in thickness, a magnetoresistive layer in the form of an NiFe layer about 30 nm in thickness, and an upper layer in the form of a tantalum layer about 1 nm in thickness, in that order. In this MR element, the NiFe layer is a soft magnetic layer with a magnetoresistive effect that serves as the magnetically sensitive portion of the MR element. In the MR element, the NiFeNb layer applies a bias magnetic field to the NiFe layer, serving as a SAL layer. However, it suffices to select a material suited to the use objective of the MR head and set a suitable film thickness; the layer thickness and material of the MR element are not specifically limited.

Further, the MR element contained in each protrusion can contain a reproduction element in addition to a recording element. The width of the gap of the recording element is desirably equal to or less than about 10 μm, preferably about 0.1 μm to about 3 μm. The width of the reproduction element in the tape running direction is desirably equal to or less than about 5 μm, preferably about 0.1 μm to about 1 μm. As set forth above, the magnetic head of the present invention can be a multichannel magnetic head comprising two or more sets of pairs of elements comprised of a recording element and a reproduction element.

The insulation material in which the MR element is embedded can be comprised of an insulating material such as alumina (Al₂O₃) or silica (SiO₂), for example. The insulating material can be comprised of AlN, Al—N—X (wherein X denotes one or more from among Si, B, Cr, Ti, Ta, and Nb), SiN, SiC, DLC, BN, MgO, SiAlON, AlON, Si₃Na, SiCO, SiON, SiCON, or the like. The thickness of the insulating material in which the MR element is embedded can be about 15 μm to about 30 μm, for example. The details of the pair of ceramic films sandwiching the insulating material are as set forth above. The thickness of each ceramic film is about 0.1 mm to about 1 mm, for example.

A specific embodiment of the method of manufacturing a head will be described next. However, the present invention is not limited to the specific embodiment given below.

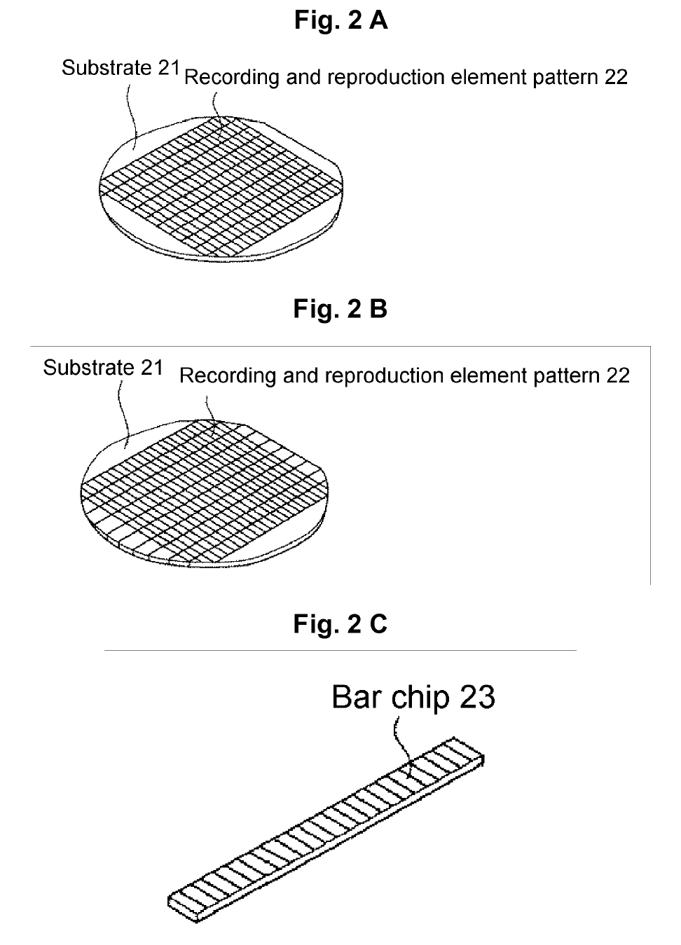

First, an MR element is formed by a thin film-forming technique on a substrate 21 comprised of AlTiC, for example. As shown in FIG. 2A, a recording and reproduction element pattern 22 comprising magnetic head part 5 (not shown) constituting the magnetic head finally obtained is formed by partitioning.

Next, as shown in FIG. 2B, substrate 21 is cut along the recording and reproduction element pattern to obtain the bar chip 23 shown in FIG. 2C.

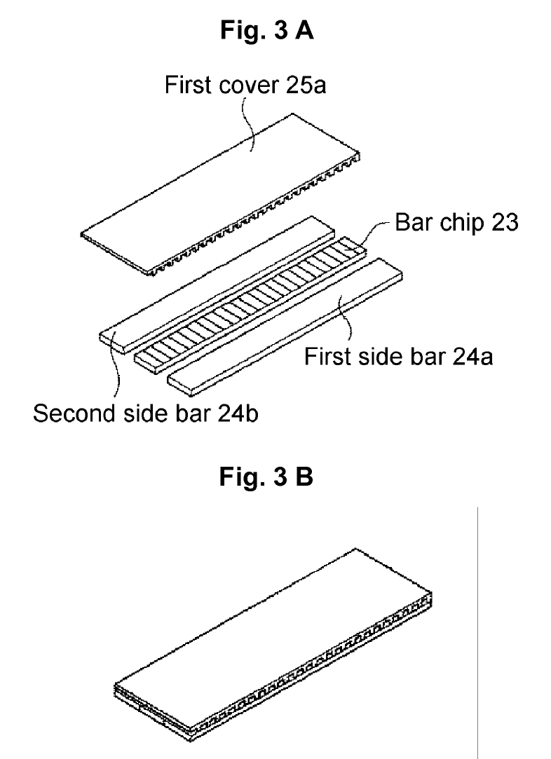

Next, as shown in FIG. 3A, first and second side bars 24a and 24b of AlTiC, calcium titanate, or the like are disposed adjacent to bar chip 23, thus determining the width of the head chip constituting the magnetic head that is finally obtained. Then, as shown in FIG. 3B, a first cover 25a of AlTiC, extending over bar chip 23 to side bars 24a and 24b, is formed as a coating by adhesion, for example, from the above surface on which recording and reproduction element pattern 22 is formed on bar chip 23.

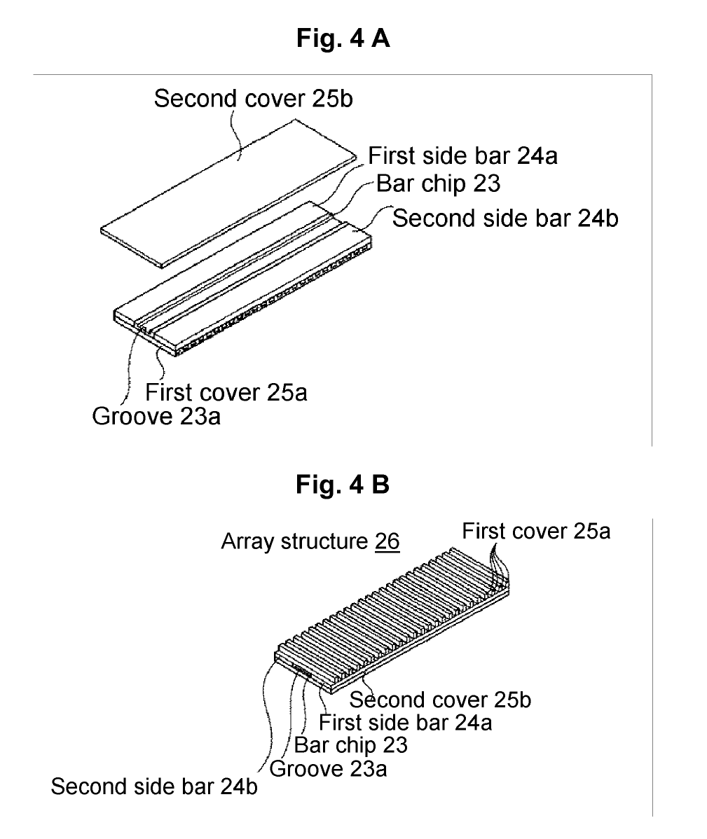

Next, as shown in FIG. 4A, on the surface of bar chip 23 on which has been coated first cover 25a, that is, on the opposite side from the surface on which the recording and reproduction element pattern has been formed, a groove 23a is formed by mechanical processing. Subsequently, a second cover 25b comprised of AlTiC and extending over bar chip 23 and side bars 24a and 24b, is coated by adhesion or the like to obtain an array structure 26.

Next, as shown in FIG. 4B, first cover 25a coated on bar chip 23 is cut into each of the head chips constituting the magnetic heads finally obtained.

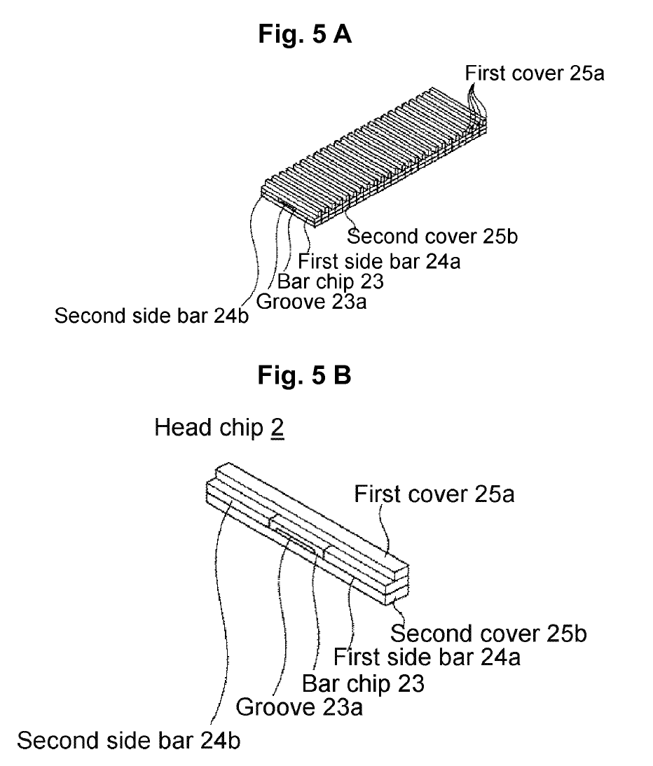

Next, as shown in FIG. 5A, bar chip 23, side bars 24a and 24b, and second cover 25b are simultaneously cut from array structure 26 to obtain the head chip 2 constituting the magnetic head that is finally obtained, as shown in FIG. 5B.

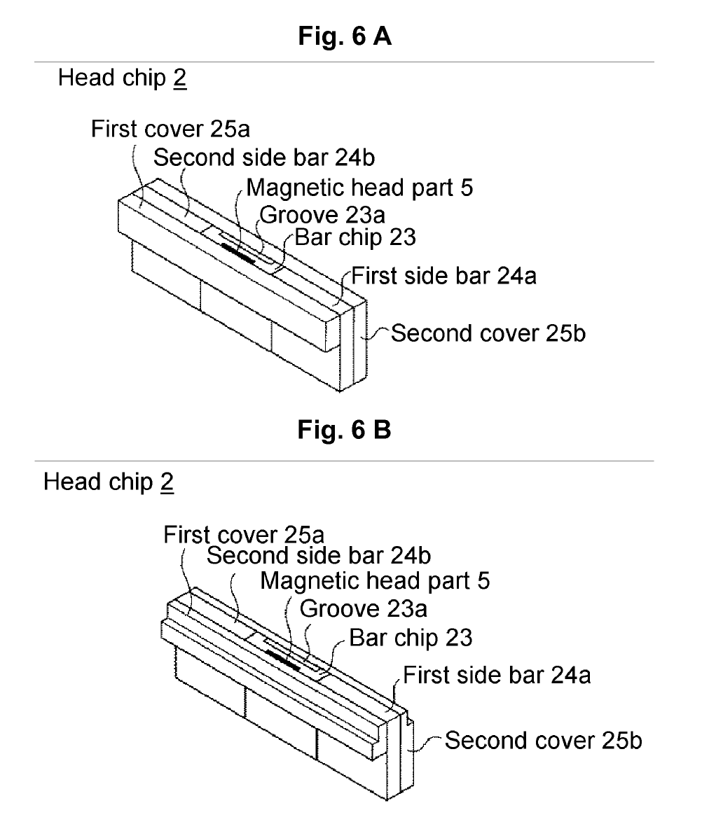

Next, as shown in FIG. 6A, the surface serving as the sliding contact surface in the magnetic head that is finally obtained is positioned on top, first and second covers 25a and 25b are polished and sliced from the top to form the contact width and sharp edges, and the external shape of head chip 2 as shown in FIG. 6B is selected.

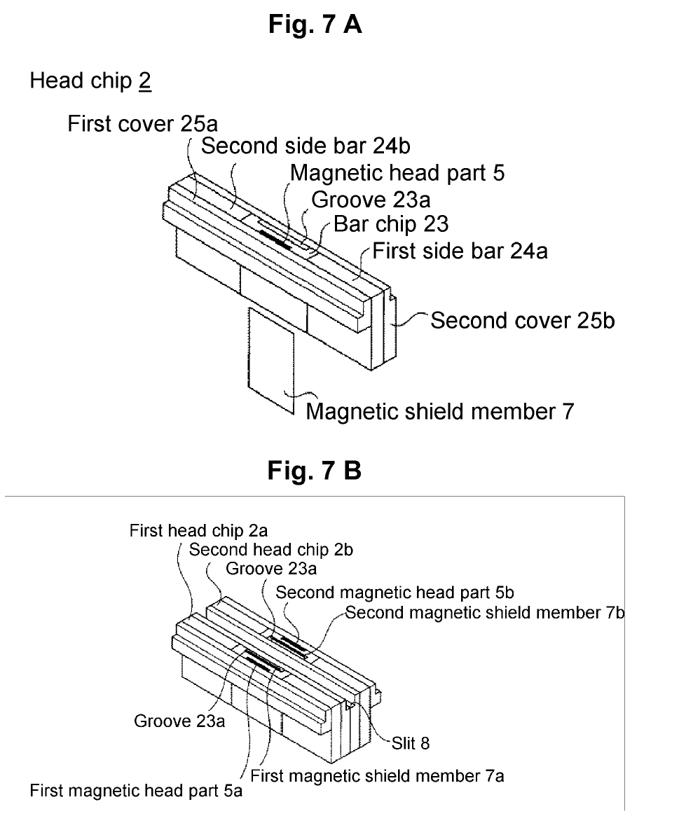

Next, as shown in FIG. 7A, a magnetic shield member 7 of a nonmagnetic material (such as copper sheet) is inserted into groove 23a serving as the cavity constituting the magnetic head that is finally obtained. Once the shield member has been secured to the lateral surface of groove 23a with adhesive, for example, as shown in FIG. 7B, a first head chip 2a and a second head chip 2b are bonded together and a slit 8 is formed based on the external shape of second cover 25b that has been selected in advance.

In the above-described embodiment, the first and second magnetic heads 5a and 5b constituting head chips 2a and 2b are disposed in an opposing structure in which they sandwich the first and second magnetic shield members 7a and 7b. Thus, it is possible to position the magnetic shield members—for preventing the recording magnetic field from one of the magnetic head members in the magnetic head that is finally obtained from affecting the reproduction element that, for example, constitutes the other magnetic head member—in close proximity to the various magnetic head members without any unusual effort.

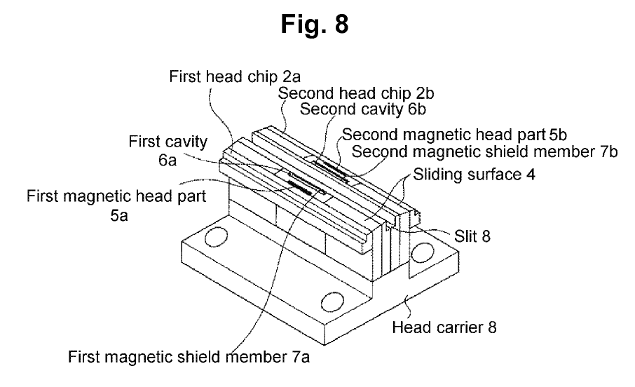

Once first head chip 2a and second head chip 2b have been bonded together, as shown in FIG. 8, head chips 2a and 2b are mounted and secured on a head carrier 3 of aluminum or brass and the opening on the underside of groove 23a constituting each of the head chips is blocked by head carrier 3 to obtain a magnetic head having two protrusions. The magnetic head obtained can be subjected to the above-described polishing to obtain the head of the present invention. For the configuration and method of manufacturing the head of the present invention, reference can be made to Japanese Unexamined Patent Publication (KOKAI) No. 2006-127730, and Japanese Unexamined Patent Publication (KOKAI) No. 2006-54044 and English language family member US 2006/0034021 A1 and U.S. Pat. No. 7,290,325, for example. The contents of the above applications are expressly incorporated herein by reference in their entirety.

### Linear Tape Drive Apparatus and Magnetic Recording and Reproduction Method

An aspect of the present invention relates to:

a linear tape drive apparatus comprising a magnetic tape and a magnetic head, wherein

the linear tape drive apparatus is a sliding-contact linear tape drive apparatus in which a magnetic head comes in sliding contact with a magnetic tape during recording and/or reproduction of a magnetic signal, and

the magnetic head is the magnetic head of the present invention; and

a magnetic recording and reproduction method, wherein

a magnetic signal is linearly recorded and/or reproduced on a magnetic tape while a magnetic head comes in sliding contact with the magnetic tape, and

the magnetic head is the magnetic head of the present invention.

The details of the magnetic head are as set forth above.

The magnetic tape contained in the linear tape drive apparatus of the present invention will be described next.

As set forth above, the magnetic head of the present invention permits the stable running in a sliding contact linear tape drive of a magnetic tape the surface smoothness of which has been increased for high-density recording. The linear tape drive apparatus of the present invention comprising such a magnetic head can comprise a magnetic tape of high surface smoothness as magnetic tape. The surface smoothness of the magnetic layer of the magnetic recording medium contained in the apparatus of the present invention is desirably such that the centerline average roughness of the surface coming in sliding contact with the magnetic head during sliding contact is equal to or lower than about 2.0 nm. Combining the head of the present invention with a magnetic tape having a centerline average roughness of equal to or lower than 2.0 nm makes it possible to achieve a recording density of, for example, equal to or higher than 6 Gbpsi, even about 10 Gbpsi. From the perspective of running stability, the centerline average roughness of the sliding contact surface of the magnetic tape with the head is desirably equal to or higher than about 0.1 nm. The centerline average roughness of the sliding contact surface of the magnetic tape with the head is preferably about 0.1 nm to about 1.5 nm, and more preferably, about 0.3 nm to about 1.3 nm. The centerline average roughness is a value that is measured with an HD2000 made by WYKO.

Examples of methods of controlling the surface smoothness of the magnetic layer are: the method of using a support of high surface smoothness; the method of providing an undercoating layer (smoothing layer) between the magnetic layer and the support; and the method of subjecting the magnetic layer to a flattening treatment (smoothing processing, calendering). Any combination of the above methods can be employed to form a magnetic layer of a high degree of surface smoothness. Smoothing processing is processing in which shear is applied in the direction of coating, immediately after coating a lower layer while the coating layer is still wet. It is effective in breaking up aggregates in the coating layer. Normally, smoothing processing is conducted by bringing a hard, platelike, flat smoother (for example, having a centerline average surface roughness Ra≦2.5 nm) into contact with a wet surface to apply shear. In calendering processing, the smoothness of the magnetic layer surface can be increased by suitably setting the calender roll temperature, pressure, speed, material, surface properties, roll structure, and the like.

The magnetic tape may be a vapor deposited magnetic recording medium having a magnetic layer comprised of a thin metal film, or a particulate magnetic recording medium. A particulate magnetic recording medium having at least one magnetic layer containing a ferromagnetic powder, binder, and abrasive may be employed.

Conventionally known thermoplastic resins, thermosetting resins, reactive resins and mixtures thereof, normally employed as binder of magnetic recording media, may be employed as binders used. These resins are described in detail in Handbook of Plastics published by Asakura Shoten, which is expressly incorporated herein by reference in its entirety. Various resins that can be employed as binder can be synthesized by a known method, and are commercially available.

Known materials chiefly having a Mohs' hardness of equal to or greater than about 6 may be employed either singly or in combination as the abrasive. These include: zirconia, alumina such as α-alumina with an α-conversion rate of equal to or greater than about 90 percent, β-alumina, silicon carbide, chromium oxide, cerium oxide, α-iron oxide, corundum, silicon nitride, titanium carbide, titanium oxide, silicon dioxide, and boron nitride. Complexes of these abrasives (obtained by surface treating one abrasive with another) may also be employed. There are cases in which compounds or elements other than the primary compound are contained in these abrasives; the effect does not change so long as the content of the primary compound is equal to or greater than about 90 weight percent. The average particle size of the abrasive is preferably about 0.01 μm to about 2 μm. To enhance electromagnetic characteristics, a narrow particle size distribution is desirable. Abrasives of differing particle size may be incorporated as needed to improve durability; the same effect can be achieved with a single abrasive as with a wide particle size distribution. It is preferable that the tap density is about 0.3 g/cc to about 2 g/cc, the moisture content is about 0.1 percent to about 5 percent, the pH is about 2 to about 11, and the specific surface area is about 1 m²/g to about 30 m²/g. The shape of the abrasive employed in the present invention may be acicular, spherical, cubic, or the like. However, a shape comprising an angular portion is desirable due to high abrasiveness. Specific examples are AKP-12, AKP-15, AKP-20, AKP-30, AKP-50, HIT-20, HIT-30, HIT-55, HIT-60, HIT-70, HIT-80, and HIT-100 made by Sumitomo Chemical Co., Ltd.; ERC-DBM, HP-DBM, and HPS-DBM made by Reynolds Corp.; WA10000 made by Fujimi Abrasive Corp.; UB20 made by Uemura Kogyo Corp.; G-5, Chromex U2, and Chromex U1 made by Nippon Chemical Industrial Co., Ltd.; TF100 and TF140 made by Toda Kogyo Corp.; Beta Random Ultrafine made by Ibiden Co., Ltd.; and B-3 made by Showa Kogyo Co., Ltd.

The volume of the ferromagnetic powder contained in the magnetic layer is desirably about 1,000 nm³ to about 20,000 nm³, preferably about 2,000 nm³ to about 8,000 nm³. Within the above range, it is possible to effectively inhibit a reduction in magnetic characteristics due to thermal variation and achieve a good C/N (S/N) ratio while keeping noise low.

The volume of the acicular powder can be calculated from the major axis length and minor axis length when envisioning a round columnar shape.

The volume of a plate-shaped powder can be calculated from the plate diameter and axial length (plate thickness) when a square columnar shape (hexagonal columnar shape in the case of hexagonal ferrite powder) is envisioned.

The volume of iron oxide powder can be calculated by envisioning a spherical shape.

The size of the magnetic material can be calculated, for example, by the following method.

First, a suitable quantity of the magnetic layer is peeled off. To about 30 mg to about 70 mg of the magnetic layer that has been peeled off is added n-butylamine, the mixture is sealed in a glass tube, and the glass tube is placed in a thermal decomposition device. The glass tube is then heated for about a day at about 140° C. After cooling, the contents are recovered from the glass tube and centrifugally separated to separate the liquid from the solid component. The solid component that has been separated is cleaned with acetone to obtain a powder sample for a transmission electron microscope (TEM). The particles in this sample are photographed at a magnification of about 100,000-fold with a model H-9000 transmission electron microscope made by Hitachi and printed on photographic paper at a total magnification of about 500,000-fold to obtain particle photographs. The targeted magnetic material is selected from the particle photographs, the contours of the powder material are traced with a digitizer, and the size of the particles is measured with KS-400 image analyzer software from Carl Zeiss. The size of 500 particles is measured.

The size of a powder such as the magnetic material (referred to as the “powder size” hereinafter) in the present invention is denoted: (1) by the length of the major axis constituting the powder, that is, the major axis length, when the powder is acicular, spindle-shaped, or columnar in shape (and the height is greater than the maximum major diameter of the bottom surface); (2) by the maximum major diameter of the tabular surface or bottom surface when the powder is tabular or columnar in shape (and the thickness or height is smaller than the maximum major diameter of the tabular surface or bottom surface); and (3) by the diameter of an equivalent circle when the powder is spherical, polyhedral, or of unspecified shape and the major axis constituting the powder cannot be specified based on shape. The “diameter of an equivalent circle” refers to that obtained by the circular projection method.

The average powder size of the powder is the arithmetic average of the above powder size and is calculated by measuring five hundred primary particles in the above-described method. The term “primary particle” refers to a nonaggregated, independent particle.

The average acicular ratio of the powder refers to the arithmetic average of the value of the (major axis length/minor axis length) of each powder, obtained by measuring the length of the minor axis of the powder in the above measurement, that is, the minor axis length. The term “minor axis length” means the length of the minor axis constituting a powder for a powder size of definition (1) above, and refers to the thickness or height for definition (2) above. For (3) above, the (major axis length/minor axis length) can be deemed for the sake of convenience to be 1, since there is no difference between the major and minor axes.

When the shape of the powder is specified, for example, as in powder size definition (1) above, the average powder size refers to the average major axis length. For definition (2) above, the average powder size refers to the average plate diameter, with the arithmetic average of (maximum major diameter/thickness or height) being referred to as the average plate ratio. For definition (3), the average powder size refers to the average diameter (also called the average particle diameter). In the measurement of powder size, the standard deviation/average value, expressed as a percentage, is defined as the coefficient of variation.

The ferromagnetic powder can be selected from metal powder, Fe—Pt based powder, iron nitride powder, and hexagonal ferrite powder, preferably comprises hexagonal ferrite powder.

Examples of hexagonal ferrite powders are barium ferrite, strontium ferrite, lead ferrite, calcium ferrite, and various substitution products thereof such as Co substitution products. Specific examples are magnetoplumbite-type barium ferrite and strontium ferrite; magnetoplumbite-type ferrite in which the particle surfaces are covered with spinels; and magnetoplumbite-type barium ferrite, strontium ferrite, and the like partly comprising a spinel phase. The following may be incorporated into the hexagonal ferrite powder in addition to the prescribed atoms: Al, Si, S, Sc, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B, Ge, Nb and the like. Compounds to which elements such as Co—Zn, Co—Ti, Co—Ti—Zr, Co—Ti—Zn, Ni—Ti—Zn, Nb—Zn—Co, Sb—Zn—Co, and Nb—Zn have been added may generally also be employed. They may comprise specific impurities depending on the starting materials and manufacturing methods employed.

The average plate diameter of the hexagonal ferrite powder is desirably about 10 nm to about 40 nm, preferably about 10 nm to about 30 nm, and more preferably about 15 nm to about 25 nm.

An average plate ratio [arithmetic average of (plate diameter/plate thickness)] preferably ranges from about 1 to about 15, more preferably about 1 to about 7. When the average plate diameter ranges from about 1 to about 15, adequate orientation can be achieved while maintaining high filling property in the magnetic layer, as well as increased noise due to stacking between particles can be suppressed. The specific surface area by BET method (S_{BET}) within the above particle size range is preferably equal to or higher than about 40 m²/g, more preferably about 40 m²/g to about 200 m²/g, and particularly preferably, about 60 m²/g to about 100 m²/g.

Narrow distributions of particle plate diameter and plate thickness of the hexagonal ferrite powder are normally good. 500 particles can be randomly measured in a transmission electron microscope (TEM) photograph of particles to measure the particle plate diameter and plate thickness. The distributions of particle plate diameter and plate thickness are often not a normal distribution. However, when expressed as the standard deviation to the average size, a/average size is normally about 0.1 to about 1.0. The particle producing reaction system can be rendered as uniform as possible and the particles produced can be subjected to a distribution-enhancing treatment to achieve a narrow particle size distribution. For example, methods such as selectively dissolving ultrafine particles in an acid solution by dissolution are known.

A coercivity (Hc) of the hexagonal ferrite powder of about 143.3 kA/m to about 318.5 kA/m (about 1800 Oe to about 4,000 Oe) can normally be achieved. The coercivity (Hc) of the hexagonal ferrite powder preferably ranges from about 159.2 kA/m to about 238.9 kA/m (about 2,000 Oe to about 3,000 Oe), more preferably about 191.0 kA/m to about 214.9 kA/m (about 2,200 Oe to about 2,800 Oe). The coercivity (Hc) can be controlled by particle size (plate diameter and plate thickness), the types and quantities of elements contained, substitution sites of the element, the particle producing reaction conditions, and the like.

The saturation magnetization (σₛ) of the hexagonal ferrite powder preferably ranges from about 30 A·m²/kg to about 80 A·m²/kg (about 30 emu/g to about 80 emu/g). The higher saturation magnetization (σₛ) is preferred, however, it tends to decrease with decreasing particle size. Known methods of improving saturation magnetization (σₛ) are combining spinel ferrite with magnetoplumbite ferrite, selection of the type and quantity of elements incorporated, and the like. It is also possible to employ W-type hexagonal ferrite. When dispersing the magnetic material, the particle surface of the magnetic material can be processed with a substance suited to a dispersion medium and a polymer. Both organic and inorganic compounds can be employed as surface treatment agents. Examples of the principal compounds are oxides and hydroxides of Si, Al, P, and the like; various silane coupling agents; and various titanium coupling agents. The quantity of surface treatment agent added range from, for example, about 0.1 weight percent to about 10 weight percent relative to the weight of the ferromagnetic powder. The pH of the ferromagnetic powder is also important to dispersion. A pH of about 4 to about 12 is usually optimum for the dispersion medium and polymer. From the perspective of the chemical stability and storage properties of the medium, a pH of about 6 to about 11 can be selected. Moisture contained in the magnetic material may also affect dispersion. There is an optimum level for the dispersion medium and polymer, usually selected from the range of about 0.01 percent to about 2.0 percent.

Methods of manufacturing the hexagonal ferrite powder include: (1) a vitrified crystallization method consisting of mixing into a desired ferrite composition barium oxide, iron oxide, and a metal oxide substituting for iron with a glass forming substance such as boron oxide; melting the mixture; rapidly cooling the mixture to obtain an amorphous material; reheating the amorphous material; and refining and comminuting the product to obtain a barium ferrite crystal powder; (2) a hydrothermal reaction method consisting of neutralizing a barium ferrite composition metal salt solution with an alkali; removing the by-product; heating the liquid phase to equal to or greater than about 100° C.; and washing, drying, and comminuting the product to obtain barium ferrite crystal powder; and (3) a coprecipitation method consisting of neutralizing a barium ferrite composition metal salt solution with an alkali; removing the by-product; drying the product and processing it at equal to or less than about 1,100° C.; and comminuting the product to obtain barium ferrite crystal powder. Any manufacturing method can be selected in the present invention. As needed, the hexagonal ferrite powder can be surface treated with Al, Si, P, or an oxide thereof. The quantity is set to, for example, about 0.1 weight percent to about 10 weight percent relative to the ferromagnetic powder. When applying a surface treatment, the quantity of a lubricant such as a fatty acid that is adsorbed is desirably not greater than about 100 mg/m². The ferromagnetic powder will sometimes contain inorganic ions such as soluble Na, Ca, Fe, Ni, or Sr. These are desirably substantially not present, but seldom affect characteristics at equal to or less than about 200 ppm.

As the magnetic tape, those comprising a nonmagnetic layer comprising a nonmagnetic powder and a binder between a nonmagnetic support and a magnetic layer can be employed.

Both organic and inorganic substances may be employed as the nonmagnetic powder in the nonmagnetic layer. Carbon black may also be employed. Examples of inorganic substances are metals, metal oxides, metal carbonates, metal sulfates, metal nitrides, metal carbides, and metal sulfides.

Specifically, titanium oxides such as titanium dioxide, cerium oxide, tin oxide, tungsten oxide, ZnO, ZrO₂, SiO₂, Cr₂O₃, α-alumina with an α-conversion rate of about 90 percent to about 100 percent, β-alumina, γ-alumina, α-iron oxide, goethite, corundum, silicon nitride, titanium carbide, magnesium oxide, boron nitride, molybdenum disulfide, copper oxide, MgCO₃, CaCO₃, BaCO₃, SrCO₃, BaSO₄, silicon carbide, and titanium carbide may be employed singly or in combinations of two or more. α-iron oxide and titanium oxide are preferred.

The nonmagnetic powder may be acicular, spherical, polyhedral, or plate-shaped. The crystallite size of the nonmagnetic powder preferably ranges from about 4 nm to about 500 nm, more preferably from about 40 nm to about 100 nm. A crystallite size falling within a range of about 4 nm to about 500 nm is desirable in that it can facilitate dispersion and impart a suitable surface roughness. The average particle diameter of the nonmagnetic powder preferably ranges from about 5 nm to about 500 nm. As needed, nonmagnetic powders of differing average particle diameter may be combined; the same effect may be achieved by broadening the average particle distribution of a single nonmagnetic powder. The particularly preferred average particle diameter of the nonmagnetic powder ranges from about 10 nm to about 200 nm. Within a range of about 5 nm to about 500 nm, dispersion can be good and a nonmagnetic layer with suitable surface roughness can be achieved; the above range is preferred.

The specific surface area of the nonmagnetic powder ranges from, for example, about 1 m²/g to about 150 m²/g, preferably from about 20 m²/g to about 120 m²/g, and more preferably from about 50 m²/g to about 100 m²/g. Within the specific surface area ranging from about 1 m²/g to about 150 m²/g, suitable surface roughness can be achieved and dispersion is possible with the desired quantity of binder; the above range is preferred. Oil absorption capacity using dibutyl phthalate (DBP) preferably ranges from about 5 mL/100 g to about 100 mL/100 g, more preferably from about 10 mL/100 g to about 80 mL/100 g, and further preferably from about 20 mL/100 g to about 60 mL/100 g. The specific gravity ranges from, for example, about 1 to about 12, preferably from about 3 to about 6. The tap density ranges from, for example, about 0.05 g/mL to about 2 g/mL, preferably from about 0.2 g/mL to about 1.5 g/mL. A tap density falling within a range of about 0.05 g/mL to about 2 g/mL can reduce the amount of scattering particles, thereby facilitating handling, and tends to prevent solidification to the device. The pH of the nonmagnetic powder preferably ranges from about 2 to about 11, more preferably from about 6 to about 9. When the pH falls within a range of about 2 to about 11, the coefficient of friction does not become high at high temperature or high humidity or due to the freeing of fatty acids. The moisture content of the nonmagnetic powder ranges from, for example, about 0.1 weight percent to about 5 weight percent, preferably from about 0.2 weight percent to about 3 weight percent, and more preferably from about 0.3 weight percent to about 1.5 weight percent. A moisture content falling within a range of about 0.1 weight percent to about 5 weight percent is desirable because it can produce good dispersion and yield a stable coating viscosity following dispersion. An ignition loss of equal to or less than about 20 weight percent is desirable and nonmagnetic powders with low ignition losses are desirable.

When the nonmagnetic powder is an inorganic powder, the Mohs' hardness is preferably about 4 to about 10. Durability can be ensured if the Mohs' hardness ranges from about 4 to about 10. The stearic acid (SA) adsorption capacity of the nonmagnetic powder preferably ranges from about 1 μmol/m² to about 20 μmol/m², more preferably from about 2 μmol/m² to about 15 μmol/m². The heat of wetting in 25° C. water of the nonmagnetic powder is preferably within a range of about 200 erg/cm² to about 600 erg/cm² (about 200 mJ/m² to about 600 mJ/m²). A solvent with a heat of wetting within this range may also be employed. The quantity of water molecules on the surface at 100 to 400° C. suitably ranges from about 1 to 10 pieces per 100 Angstroms. The pH of the isoelectric point in water preferably ranges from about 3 to about 9. The surface of these nonmagnetic powders preferably contains Al₂O₃, SiO₂, TiO₂, ZrO₂, SnO₂, Sb₂O₃, and ZnO by conducting surface treatment. The surface-treating agents of preference with regard to dispersibility are Al₂O₃, SiO₂, TiO₂, and ZrO₂, and Al₂O₃, SiO₂ and ZrO₂ are further preferable. They may be employed singly or in combination. Depending on the objective, a surface-treatment coating layer with a coprecipitated material may also be employed, the method which comprises a first alumina coating and a second silica coating thereover or the reverse method thereof may also be adopted. Depending on the objective, the surface-treatment coating layer may be a porous layer, with homogeneity and density being generally desirable.

Specific examples of nonmagnetic powders suitable for use in the nonmagnetic layer are: Nanotite from Showa Denko K. K.; HIT-100 and ZA-G1 from Sumitomo Chemical Co., Ltd.; DPN-250, DPN-250BX, DPN-245, DPN-270BX, DPN-550BX and DPN-550RX from Toda Kogyo Corp.; titanium oxide TTO-51B, TTO-55A, TTO-55B, TTO-55C, TTO-555, TTO-55D, SN-100, MJ-7, α-iron oxide E270, E271 and E300 from Ishihara Sangyo Co., Ltd.; STT-4D, STT-30D, STT-30 and STT-65C from Titan Kogyo K. K.; MT-100S, MT-100T, MT-150W, MT-500B, T-600B, T-100F and T-500HD from Tayca Corporation; FINEX-25, BF-1, BF-10, BF-20 and ST-M from Sakai Chemical Industry Co., Ltd.; DEFIC-Y and DEFIC-R from Dowa Mining Co., Ltd.; AS2BM and TiO2P25 from Nippon Aerogil; 100A and 500A from Ube Industries, Ltd.; Y-LOP from Titan Kogyo K. K.; and sintered products of the same. Particular preferable nonmagnetic powders are titanium dioxide and α-iron oxide.

Carbon black may be combined with nonmagnetic powder in the nonmagnetic layer to reduce surface resistivity, reduce light transmittance, and achieve a desired micro-Vickers hardness. The micro-Vickers hardness of the nonmagnetic layer is normally about 25 kg/mm² to about 60 kg/mm² (about 245 MPa to about 588 MPa), desirably about 30 kg/mm² to about 50 kg/mm² (about 294 MPa to about 490 MPa) to adjust head contact. It can be measured with a thin film hardness meter (HMA-400 made by NEC Corporation) using a diamond triangular needle with a tip radius of about 0.1 micrometer and an edge angle of about 80 degrees as indenter tip. “Techniques for evaluating thin-film mechanical characteristics,” Realize Corp. can be referred to for details. The light transmittance is generally standardized to an infrared absorbance at a wavelength of about 900 nm equal to or less than about 3 percent. For example, in VHS magnetic tapes, it has been standardized to equal to or less than 0.8 percent. To this end, furnace black for rubber, thermal black for rubber, black for coloring, acetylene black and the like may be employed.

The specific surface area of the carbon black employed in the nonmagnetic layer is, for example, about 100 m²/g to about 500 m²/g, preferably about 150 m²/g to about 400 m²/g. The DBP oil absorption capability is, for example, about 20 mL/100 g to about 400 mL/100 g, preferably about 30 mL/100 g to about 200 mL/100 g. The particle diameter of the carbon black is, for example, about 5 nm to about 80 nm, preferably about 10 nm to about 50 nm, and more preferably, about 10 nm to about 40 nm. It is preferable that the pH of the carbon black is about 2 to about 10, the moisture content is about 0.1 to about 10 percent, and the tap density is about 0.1 g/mL to about 1 g/mL.

Specific examples of types of carbon black employed in the nonmagnetic layer are: BLACK PEARLS 2000, 1300, 1000, 900, 800, 880, 700 and VULCAN XC-72 from Cabot Corporation; #3050B, #3150B, #3250B, #3750B, #3950B, #950, #650B, #970B, #850B and MA-600 from Mitsubishi Chemical Corporation; CONDUCTEX SC, RAVEN 8800, 8000, 7000, 5750, 5250, 3500, 2100, 2000, 1800, 1500, 1255 and 1250 from Columbia Carbon Co., Ltd.; and Ketjen Black EC from Ketjen Black International Co., Ltd.

The carbon black employed may be surface-treated with a dispersant or grafted with resin, or have a partially graphite-treated surface. The carbon black may be dispersed in advance into the binder prior to addition to the coating liquid. The quantity of the carbon black is preferably within a range not exceeding about 50 weight percent of the inorganic powder as well as not exceeding 40 percent of the total weight of the nonmagnetic layer. These carbon blacks may be used singly or in combination. For example, the Carbon Black Handbook compiled by the Carbon Black Association, which is expressly incorporated herein by reference in its entirety, may be consulted for types of carbon black suitable for use in the nonmagnetic layer of the present invention.

Based on the objective, an organic powder may be added to the nonmagnetic layer. Examples of such an organic powder are acrylic styrene resin powders, benzoguanamine resin powders, melamine resin powders, and phthalocyanine pigments. Polyolefin resin powders, polyester resin powders, polyamide resin powders, polyimide resin powders, and polyfluoroethylene resins may also be employed. The manufacturing methods described in Japanese Unexamined Patent Publication (KOKAI) Showa Nos. 62-18564 and 60-255827, which are expressly incorporated herein by reference in their entirety, may be employed.

Binders, lubricants, dispersing agents, additives, solvents, dispersion methods, and the like suited to the magnetic layer may be adopted to the nonmagnetic layer. In particular, known techniques for the quantity and type of binder and the quantity and type of additives and dispersion agents employed in the magnetic layer may be adopted thereto.

An undercoating layer can be provided in the magnetic recording medium employed in the present invention. Providing an undercoating layer can enhance adhesive strength between the support and the magnetic layer or nonmagnetic layer. For example, a polyester resin that is soluble in solvent can be employed as the undercoating layer.

A known film in the form of a polyester such as polyethylene terephthalate or polyethylene naphthalate, polyolefins, cellulose triacetate, polycarbonate, polyamide, polyimide, polyamidoimide, polysulfone, polyaramide, aromatic polyamide, or polybenzooxazole can be employed as the nonmagnetic support. The use of a high-strength support such as polyethylene naphthalate or polyamide is desirable. As needed, laminated supports such as those disclosed in Japanese Unexamined Patent Publication (KOKAI) Heisei No. 3-224127 can be employed to vary the surface roughness of the magnetic surface and the nonmagnetic support surface. The content of the above publication is expressly incorporated herein by reference in its entirety. These supports can be corona discharge treated, plasma treated, treated to facilitate adhesion, heat treated, treated to remove dust, or the like in advance. An aluminum or glass substrate can also be employed as the support.

The thickness of the nonmagnetic support desirably ranges from about 3 μm to about 80 μm, preferably from about 3 μm to about 50 μm, and more preferably, about 3 μm to about 10 μm. The centerline average roughness (Ra of the support surface is preferably equal to or lower than about 4 nm, more preferably equal to or lower than about 2 nm. The above Ra is a value measured by HD2000 made by WYKO.

The Young's modulus of the nonmagnetic support both in the longitudinal and width directions is preferably equal to or greater than about 6.0 GPa, preferably equal to or greater than about 7.0 GPa.

As for the thickness structure of the magnetic tape employed in the present invention, the thickness of the nonmagnetic support desirably ranges from about 3 μm to about 80 μm, preferably from about 3 μm to about 50 μm, and more preferably, about 3 μm to about 10 μm, as set forth above. When an undercoating layer is provided between the nonmagnetic support and the nonmagnetic layer or the magnetic layer, the thickness of the undercoating layer ranges from, for example, about 0.01 μm to about 0.8 μm, preferably about 0.02 μm to about 0.6 μm.

An intermediate layer can be provided between the support and the nonmagnetic layer or the magnetic layer to improve smoothness. For example, the intermediate layer can be formed by coating and drying a coating liquid comprising a polymer on the surface of the nonmagnetic support, or by coating a coating liquid comprising a compound (radiation-curable compound) comprising intramolecular radiation-curable functional groups and then irradiating it with radiation to cure the coating liquid.

A radiation-curable compound having a molecular weight ranging from about 200 to about 2,000 is desirably employed. When the molecular weight is within the above range, the relatively low molecular weight can facilitate coating flow during the calendering step, increasing moldability and permitting the formation of a smooth coating.

A radiation-curable compound in the form of a bifunctional acrylate compound with the molecular weight of about 200 to about 2,000 is desirable. Bisphenol A, bisphenol F, hydrogenated bisphenol A, hydrogenated bisphenol F, and compounds obtained by adding acrylic acid or methacrylic acid to alkylene oxide adducts of these compounds are preferred.

The radiation-curable compound can be used in combination with a polymeric binder. Examples of the binder employed in combination are conventionally known thermoplastic resins, thermosetting resins, reactive resins, and mixtures thereof. When the radiation employed is UV radiation, a polymerization initiator is desirably employed in combination. A known photoradical polymerization initiator, photocationic polymerization initiator, photoamine generator, or the like can be employed as the polymerization initiator.

A radiation-curable compound can also be employed in the nonmagnetic layer.

The thickness of the magnetic layer can be optimized based on the saturation magnetization of the head employed, the length of the head gap, and the recording signal band, and is normally about 10 nm to about 150 nm, preferably about 20 nm to about 120 nm, more preferably about 30 nm to about 100 nm, and further preferably about 30 nm to 80 nm. The thickness variation (σ/δ) in the magnetic layer is preferably within about ±50 percent, more preferably within about ±30 percent. At least one magnetic layer is sufficient. The magnetic layer may be divided into two or more layers having different magnetic characteristics, and a known configuration relating to multilayered magnetic layer may be applied.

The thickness of the nonmagnetic layer preferably ranges from about 0.01 μm to about 1 μm. The nonmagnetic layer is effective so long as it is substantially nonmagnetic in the magnetic recording medium of the present invention. For example, even when it comprises impurities or trace amounts of magnetic material that have been intentionally incorporated, it can be viewed as a nonmagnetic layer so long as the residual magnetic flux density is equal to or less than about 10 mT, or a coercivity is equal to or less than about 7.96 kA/m (100 Oe), it being preferable not to have a residual magnetic flux density or coercivity at all.

The backcoat layer can be provided on the opposite surface of the nonmagnetic support from the surface on which the magnetic layer is provided, in the magnetic tape employed in the present invention. The backcoat layer desirably comprises carbon black and inorganic powder. The formula of the magnetic layer or nonmagnetic layer can be applied to the binder and various additives. The backcoat layer is preferably equal to or less than about 0.9 μm, more preferably about 0.1 μm to about 0.7 μm, in thickness.

The method of manufacturing a magnetic tape will be described below.

The process for manufacturing a magnetic layer coating liquid or a coating liquid for forming a nonmagnetic layer or a backcoat layer can comprise at least a kneading step, a dispersing step, and a mixing step to be carried out, if necessary, before and/or after the kneading and dispersing steps. Each of the individual steps may be divided into two or more stages. All of the starting materials employed in the present invention, including the ferromagnetic powder, nonmagnetic powder, binders, carbon black, abrasives, antistatic agents, lubricants, solvents, and the like, may be added at the beginning of, or during, any of the steps. Moreover, the individual starting materials may be divided up and added during two or more steps. For example, polyurethane may be divided up and added in the kneading step, the dispersion step, and the mixing step for viscosity adjustment after dispersion. To achieve the object of the present invention, conventionally known manufacturing techniques may be utilized for some of the steps. A kneader having a strong kneading force, such as an open kneader, continuous kneader, pressure kneader, or extruder is preferably employed in the kneading step. Details of the kneading process are described in Japanese Unexamined Patent Publication (KOKAI) Heisei Nos. 1-106338 and 1-79274. The contents of these publications are incorporated herein by reference in their entirety. Further, glass beads may be employed to disperse the magnetic layer, nonmagnetic layer or backcoat layer coating liquid, with a dispersing medium with a high specific gravity such as zirconia beads, titania beads, and steel beads being suitable for use. The particle diameter and fill ratio of these dispersing media can be optimized for use. A known dispersing device may be employed.

To fabricate a magnetic tape, the magnetic layer can be formed by coating a magnetic layer coating liquid to prescribed thickness on the surface of a running nonmagnetic support, for example. Multiple magnetic layer coating liquids may be successively or simultaneously coated in a multilayer coating, or a nonmagnetic layer coating liquid and a magnetic layer coating liquid may be successively or simultaneously coated in a multilayer coating. Coating machines suitable for use in coating the magnetic layer or nonmagnetic layer coating liquid are air doctor coaters, blade coaters, rod coaters, extrusion coaters, air knife coaters, squeeze coaters, immersion coaters, reverse roll coaters, transfer roll coaters, gravure coaters, kiss coaters, cast coaters, spray coaters, spin coaters, and the like. For example, “Recent Coating Techniques” (May 31, 1983), issued by the Sogo Gijutsu Center K.K. may be referred to in this regard.

For a magnetic tape, the coating layer that is formed by applying the magnetic layer coating liquid can be magnetic field orientation processed using cobalt magnets or solenoids on the ferromagnetic powder contained in the coating layer. When it is a disk, an adequately isotropic orientation can be achieved in some products without orientation using an orientation device, but the use of a known random orientation device in which cobalt magnets are alternately arranged diagonally, or alternating fields are applied by solenoids, is desirable. In the case of ferromagnetic metal powder, the term “isotropic orientation” generally refers to a two-dimensional in-plane random orientation, which is desirable, but can refer to a three-dimensional random orientation achieved by imparting a perpendicular component. Further, a known method, such as opposing magnets of opposite poles, can be employed to effect perpendicular orientation, thereby imparting an isotropic magnetic characteristic in the peripheral direction. Perpendicular orientation is particularly desirable when conducting high-density recording. Spin coating can be used to effect peripheral orientation.

The drying position of the coating is desirably controlled by controlling the temperature and flow rate of drying air, and coating speed. A coating speed of about 20 m/min to about 1,000 m/min and a dry air temperature of equal to or higher than about 60° C. are desirable. Suitable predrying can be conducted prior to entry into the magnet zone.

The coated stock material thus obtained can be normally temporarily wound on a take-up roll, and then unwound from the take-up roll and calendered.

For example, super calender rolls or the like can be employed in calendering. Calendering can enhance surface smoothness, eliminate voids produced by the removal of solvent during drying, and increase the fill rate of the ferromagnetic powder in the magnetic layer, thus yielding a magnetic recording medium of good electromagnetic characteristics. The calendering step is desirably conducted by varying the calendering conditions based on the smoothness of the surface of the coated stock material.

The glossiness of the coated stock material may decrease roughly from the center of the take-up roll toward the outside, and there is sometimes variation in the quality in the longitudinal direction. Glossiness is known to correlate (proportionally) to the surface roughness Ra. Accordingly, when the calendering conditions are not varied in the calendering step, such as by maintaining a constant calender roll pressure, there is no countermeasure for the difference in smoothness in the longitudinal direction resulting from winding of the coated stock material, and the variation in quality in the longitudinal direction carries over into the final product.

Accordingly, in the calendering step, it is desirable to vary the calendering conditions, such as the calender roll pressure, to cancel out the different in smoothness in the longitudinal direction that is produced by winding of the coated stock material. Specifically, it is desirable to reduce the calender roll pressure from the center to the outside of the coated stock material that is wound off the take-up roll. Based on an investigation by the present inventors, lowering the calender roll pressure decreases the glossiness (smoothness diminishes). Thus, the difference in smoothness in the longitudinal direction that is produced by winding of the coated stock material is cancelled out, yielding a final product free of variation in quality in the longitudinal direction.

An example of changing the pressure of the calender rolls has been described above. Additionally, it is possible to control the calender roll temperature, calender roll speed, and calender roll tension. Taking into account the properties of a particulate medium, it is desirable to control the surface smoothness by means of the calender roll pressure and calender roll temperature. The calender roll pressure is reduced, or the calender roll temperature is lowered, to diminish the surface smoothness of the final product. Conversely, the calender roll pressure is increased or the calender roll temperature is raised to increase the surface smoothness of the final product.

Alternatively, the magnetic recording medium obtained following the calendering step can be thermally processed to promote thermal curing. Such thermal processing can be suitably determined based on the blending formula of the magnetic layer coating liquid, for example, at about 35° C. to about 100° C., desirably at about 50° C. to about 80° C. The thermal processing time is, for example, about 12 hours to about 72 hours, desirably about 24 hours to about 48 hours.

Rolls of a heat-resistant plastic such as epoxy, polyimide, polyamide, or polyamidoimide, can be employed as the calender rolls. Processing with metal rolls is also possible.

Examples of calendering conditions are as follows. The calender roll temperature is, for example, set to within a range of about 60° C. to about 100° C., desirably within a range of about 70° C. to about 100° C., and preferably within a range of about 80° C. to about 100° C. The pressure, for example, ranges from about 100 kg/cm to about 500 kg/cm (about 98 kN/m to about 490 kN/m), desirably ranges from about 200 kg/cm to about 450 kg/cm (about 196 kN/m to about 441 kN/m), and preferably, ranges from about 300 kg/cm to about 400 kg/cm (about 294 kN/m to about 392 kN/m).

Details of the centerline average roughness of the magnetic layer are as set forth above. The ten-point average roughness Rz of the magnetic layer is desirably equal to or less than about 30 nm. These values can be controlled by controlling the surface properties with the filler in the support, the roll surface shape during calendaring, and the like. The curl is desirably within about ±3 mm.

The magnetic tape obtained can be cut to desired size with a cutter or the like for use. The cutter is not specifically limited, but desirably comprises multiple sets of a rotating upper blade (male blade) and lower blade (female blade). The slitting speed, engaging depth, peripheral speed ratio of the upper blade (male blade) and lower blade (female blade) (upper blade peripheral speed/lower blade peripheral speed), period of continuous use of slitting blade, and the like are suitably selected.

The saturation magnetic flux density of the magnetic tape employed in the present invention is preferably about 100 mT to about 400 mT. The coercivity (Hc) of the magnetic tape is preferably about 142 kA/m to about 276 kA/m. Narrower coercivity distribution is preferable. The SFD and SFDr are preferably equal to or lower than about 0.6, more preferably equal to or lower than about 0.3.

The coefficient of friction of the magnetic tape employed in the present invention relative to the head is desirably equal to or less than about 0.50 and preferably equal to or less than about 0.30 at temperatures ranging from −10° C. to 40° C. and humidity ranging from 0 percent to 95 percent, the surface resistivity on the magnetic surface preferably ranges from about 10⁴ ohm/sq to about 10⁸ ohm/sq, and the charge potential preferably ranges from about ±500 V to about +500 V. The modulus of elasticity at 0.5 percent extension of the magnetic layer preferably ranges from about 0.98 GPa to about 19.6 GPa (about 100 kg/mm² to about 2,000 kg/mm²) in each in-plane direction. The breaking strength preferably ranges from about 98 MPa to about 686 MPa (about 10 kg/mm² to 70 kg/mm²). The modulus of elasticity of the magnetic tape preferably ranges from about 0.98 GPa to about 14.7 GPa (about 100 kg/mm² to about 1500 kg/mm²) in each in-plane direction. The residual elongation is preferably equal to or less than about 0.5 percent, and the thermal shrinkage rate at all temperatures below 100° C. is preferably equal to or less than about 1 percent, more preferably equal to or less than about 0.5 percent, and most preferably equal to or less than about 0.1 percent.

The glass transition temperature (i.e., the temperature at which the loss tangent of dynamic viscoelasticity peaks as measured at 110 Hz with a dynamic viscoelastometer, such as RHEOVIBRON) of the magnetic layer preferably ranges from about 50° C. to about 180° C., and that of the nonmagnetic layer preferably ranges from about 0° C. to about 180° C. The loss elastic modulus preferably falls within a range of about 1×10⁷ Pa to about 8×10⁸ Pa (about 1×10⁸ dyne/cm² to about 8×10⁹ dyne/cm²) and the loss tangent is preferably equal to or less than about 0.2. Adhesion failure tends to occur when the loss tangent becomes excessively large. These thermal characteristics and mechanical characteristics are desirably nearly identical, varying by equal to or less than about 10 percent, in each in-plane direction of the medium.

The residual solvent contained in the magnetic layer is preferably equal to or less than about 100 mg/m² and more preferably equal to or less than about 10 mg/m². The void ratio in the coated layers, including both the nonmagnetic layer and the magnetic layer, is preferably equal to or less than about 40 volume percent, more preferably equal to or less than about 30 volume percent. Although a low void ratio is preferable for attaining high output, there are some cases in which it is better to ensure a certain level based on the object. For example, in many cases, larger void ratio permits preferred running durability in disk media in which repeat use is important.

Physical properties of the nonmagnetic layer and magnetic layer may be varied based on the objective in the magnetic tape. For example, the modulus of elasticity of the magnetic layer may be increased to improve running durability while simultaneously employing a lower modulus of elasticity than that of the magnetic layer in the nonmagnetic layer to improve the head contact of the magnetic recording medium.

### Method of Manufacturing Magnetic Head

A further aspect of the present invention relates to a method of manufacturing the magnetic head of the present invention. The method of manufacturing the magnetic head of the present invention comprises preparing a head chip comprising a recording element and/or a reproduction element between a pair of ceramic films, and polishing a surface of the ceramic films to form the indentations satisfying (1) to (4) above.

The ceramic films are desirably AlTiC, comprised of a TiC phase and an Al₂O₃ phase, in which the weight ratio of TiC/Al₂O₃ falls within a range of about 20/80 to about 50/50. In the polishing, the TiC phase can be removed to expose the Al₂O₃ phase, forming indentations that satisfy (1) to (4) above. The details of the method of manufacturing the magnetic head of the present invention are as set forth above.

### EXAMPLES

The present invention will be described in detail below based on examples. However, the present invention is not limited to the examples. The term “parts” given in Examples are weight parts unless specifically stated otherwise.

### Example 1

### Preparation of Magnetic Tape (Polishing Tape)

### 1. Components of Magnetic Layer Coating Liquid

| | | |
|---|---|---|
| Ferromagnetic plate-shaped hexagonal ferrite powder | 100 | parts |
| Composition other than oxygen (molar ratio): | | |
| Ba/Fe/Co/Zn = 1/9/0.2/1 | | |
| Hc: 176 kA/m (2200 Oe) | | |
| Average plate diameter: 20 nm | | |
| Average plate ratio: 3 | | |
| BET specific surface area: 65 m²/g | | |
| σs: 49 A · m²/kg (49 emu/g) | | |
| Polyurethane resin based on branched side | 17 | parts |
| chain-comprising polyester polyol/diphenylmethane | | |
| diisocyanate, —SO₃Na = 400 eq/ton | | |
| α-Al₂O₃ (particle size: 0.15 μm) | 5 | parts |
| Carbon black (average particle diameter: 20 nm) | 1 | part |
| Cyclohexanone | 110 | parts |
| Methyl ethyl ketone | 100 | parts |
| Toluene | 100 | parts |
| Butyl stearate | 2 | parts |
| Stearic acid | 1 | part |

### 2. Components of Backcoat Layer Coating Liquid

| | |
|---|---|
| Nonmagnetic inorganic powder | 85 parts |
| α-iron oxide | |
| Surface treatment layer: Al₂O₃, SiO₂ | |
| Average major axis length: 0.15 μm | |
| Tap density: 0.8 | |
| Average acicular ratio: 7 | |
| BET specific surface area: 52 m²/g | |
| pH: 8 | |
| DBP oil absorption capacity: 33 g/100 g | |
| Carbon black | 20 parts |
| DBP oil absorption capacity: 120 mL/100 g | |
| pH: 8 | |
| BET specific surface area: 250 m²/g | |
| Volatile content: 1.5 percent | |
| Vinyl chloride resin (MR 104 made by Nippon | 13 parts |
| Zeon Co., Ltd.) | |
| Polyurethane resin (UR8200 made by Toyobo Co., Ltd.) | 6 parts |
| Phenylphosphonic acid | 3 parts |
| Alumina powder (average particle diameter: 0.8 μm) | 5 parts |
| Cyclohexanone | 140 parts |
| Methyl ethyl ketone | 170 parts |
| Butyl stearate | 2 part |
| Stearic acid | 1 part |

### 3. Components of Nonmagnetic Layer Coating Liquid

| | |
|---|---|
| Nonmagnetic inorganic powder | 85 parts |
| α-iron oxide | |
| Surface treatment layer: Al₂O₃, SiO₂ | |
| Average major axis length: 0.15 μm | |
| Tap density: 0.8 | |
| Average acicular ratio: 7 | |
| BET specific surface area: 52 m²/g | |
| pH: 8 | |
| DBP oil absorption capacity: 33 g/100 g | |
| Carbon black | 15 parts |
| DBP oil absorption capacity: 120 mL/100 g | |
| pH: 8 | |
| BET specific surface area: 250 m²/g | |
| Volatile content: 1.5 percent | |
| Vinyl chloride resin (MR 110 made by Nippon Zeon | 10 parts |
| Co., Ltd.) | |
| Polyurethane resin based on branched side chain- | 10 parts |
| comprising polyester polyol/diphenylmethane | |
| diisocyanate, —SO₃Na = 150 eq/ton | |
| Phenylphosphonic acid | 3 parts |
| Cyclohexanone | 140 parts |
| Methyl ethyl ketone | 170 parts |
| Butyl stearate | 2 part |
| Stearic acid | 1 part |

The magnetic layer coating liquid and nonmagnetic layer coating liquid were prepared as follows. The various components were kneaded in an open kneader, after which a suitable quantity of a dispersion medium in the form of zirconia beads 0.5 mm in diameter was added to the coating liquid. The mixture was then dispersed in a sand mill. To each of the magnetic layer and nonmagnetic layer dispersions thus obtained was added a trifunctional, low-molecular-weight polyisocyanate compound, followed by cyclohexanone. The mixtures were filtered with a filter having an average pore size of 1 μm to complete preparation of the magnetic layer coating liquid and nonmagnetic layer coating liquid. The nonmagnetic layer coating liquid obtained, in a quantity calculated to yield a dry thickness of 1.0 μm, and immediately thereafter, the magnetic layer coating liquid, in a quantity calculated to yield a dry thickness of 0.1 μm, were simultaneously multilayer coated on the surface of a PEN support 50 μm in thickness. While the magnetic layer coating liquid was still wet, magnetic field orientation was conducted with 0.5 T (5,000 gauss) Co magnets and 0.4 T (4,000 gauss) solenoid magnets. The solvent was dried; calendering was conducted twice with a metal roll-metal roll-metal roll-metal roll-metal roll-metal roll-metal roll combination at a rate of 50 m/min, a linear pressure of 300 kg/cm, and a temperature of 95° C.; and the product was slit to ½ inch width to produce a magnetic tape.

The centerline average roughness of the magnetic layer surface of the magnetic tape obtained was measured at 1.5 nm with an HD2000 made by WYKO.

Head Fabrication

According to the specific embodiment of the above-described head fabrication, a contour linear tape drive-use multichannel magnetic head (number of recording and reproduction elements: 15 pairs; recording gap width: 0.18 μm; reproduction element width: 0.12 μm) having two protrusions, the material of the pair of ceramic films contained in each of the protrusions being AlTiC with a TiC/Al₂O₃ (weight ratio) of 30/70, was prepared. The AlTiC films were fabricated by the following method.

TiC powder with an average particle diameter of 0.5 μm and a particle diameter standard deviation of 1.1 μm was mixed with Al₂O₃ powder in a ratio of 30/70 weight percent. A powder suspension was prepared by dispersing the mixture for 10 hours in an alumina ball mill and pulverizing it. Odorless mineral spirits (OMS) with a specific gravity of 0.7 and a dispersing agent (an ionic pigment wetting agent) were employed in the suspension.

Following dispersion in the ball mill, the codispersion was wet screened (using 300 mesh), vacuum dried at 350° C., and then screened (50 mesh). The powder was pressed into disk shape with uniaxial pressure in a hot-press furnace (processed for 20 minutes at 1,700° C. and 20 MPa), and processed with isotropic pressure (for 2 hours at 1,800° C. and 150 MPa) to fabricate a wafer 50 mm in diameter and 3.05 mm in thickness. The wafer was roughly polished with a wafer polisher (diamond 100 μm in particle diameter) to a final thickness of 2.02 mm.

Abrasive tape in the form of the magnetic tape fabricated above was brought into contact with the upper surface of the protrusions on the head that had been fabricated. This was done under conditions of 5° C. and 10 percent RH, and 5° C. and 80 percent RH, a tape speed of 0.5 m/s, a tape tension of 100 gf, and a contact angle between tape and head of 10°. A 50 m length of tape was run back and forth 4 times under these conditions.

### Example 2

With the exception that AlTiC was prepared with a TiC/Al₂O₃ (weight ratio) of 30/70 by combining 30 weight percent of TiC powder with an average particle diameter of 1.2 μm and a particle diameter standard deviation of 1.1 μm with 70 weight percent of Al₂O₃, a magnetic head was fabricated by the same method as in Example 1.

### Example 3

With the exception that AlTiC was prepared with a TiC/Al₂O₃ (weight ratio) of 30/70 by combining 30 weight percent of TiC powder with an average particle diameter of 0.8 μm and a particle diameter standard deviation of 0.7 μm with 70 weight percent of Al₂O₃, a magnetic head was fabricated by the same method as in Example 1.

### Example 4

With the exception that AlTiC was prepared with a TiC/Al₂O₃ (weight ratio) of 30/70 by combining 30 weight percent of TiC powder with an average particle diameter of 0.8 μm and a particle diameter standard deviation of 1.4 μm with 70 weight percent of Al₂O₃, a magnetic head was fabricated by the same method as in Example 1.

### Example 5

With the exception that AlTiC was prepared with a TiC/Al₂O₃ (weight ratio) of 20/80 by combining 20 weight percent of TiC powder with an average particle diameter of 0.8 μm and a particle diameter standard deviation of 1.1 μm with 80 weight percent of Al₂O₃, a magnetic head was fabricated by the same method as in Example 1.

### Example 6

With the exception that AlTiC was prepared with a TiC/Al₂O₃ (weight ratio) of 50/50 by combining 50 weight percent of TiC powder with an average particle diameter of 0.8 μm and a particle diameter standard deviation of 1.1 μm with 50 weight percent of Al₂O₃, a magnetic head was fabricated by the same method as in Example 1.

### Example 7

With the exceptions that the average particle diameter of the alumina contained in the abrasive tape was changed to 0.5 μm and AlTiC was prepared with a TiC/Al₂O₃ (weight ratio) of 30/70 by combining 30 weight percent of TiC powder with an average particle diameter of 0.8 μm and a particle diameter standard deviation of 1.1 μm with 70 weight percent of Al₂O₃, a magnetic head was fabricated by the same method as in Example 1. The centerline average roughness of the magnetic layer surface of the abrasive tape employed was measured with an HD2000 made by WYKO at 3.5 nm.

### Example 8

With the exceptions that the average particle diameter of the alumina contained in the abrasive tape was changed to 1.5 μm and AlTiC was prepared with a TiC/Al₂O₃ (weight ratio) of 30/70 by combining 30 weight percent of TiC powder with an average particle diameter of 0.8 μm and a particle diameter standard deviation of 1.1 μm with 70 weight percent of Al₂O₃, a magnetic head was fabricated by the same method as in Example 1. The centerline average roughness of the magnetic layer surface of the abrasive tape employed was measured with an HD2000 made by WYKO at 5.3 nm.

### Comparative Example 1

With the exception that TiC powder having an average particle diameter of 0.2 μm and a particle diameter standard deviation of 1.1 μm was employed, a magnetic head was fabricated by the same method as in Example 1.

### Comparative Example 2

With the exception that TiC powder having an average particle diameter of 3.0 μm and a particle diameter standard deviation of 1.1 μm was employed, a magnetic head was fabricated by the same method as in Example 1.

### Comparative Example 3

With the exception that TiC powder having an average particle diameter of 0.5 μm and a particle diameter standard deviation of 0.1 μm was employed, a magnetic head was fabricated by the same method as in Example 1.

### Comparative Example 4

With the exception that TiC powder having an average particle diameter of 0.5 μm and a particle diameter standard deviation of 3.0 μm was employed, a magnetic head was fabricated by the same method as in Example 1.

### Comparative Example 5

With the exception that the blending ratio of the AlTiC starting materials was changed to 15 weight percent TiC and 85 weight percent Al₂O₃, a magnetic head was fabricated by the same method as in Example 1.

### Comparative Example 6

With the exception that the blending ratio of the AlTiC starting materials was changed to 40 weight percent TiC and 60 weight percent Al₂O₃, a magnetic head was fabricated by the same method as in Example 1.

### Comparative Example 7

With the exception that the average particle diameter of the alumina contained in the abrasive tape was changed to 0.2 μm, a magnetic head was fabricated by the same method as in Example 1. The centerline average roughness of the magnetic layer surface of the abrasive tape employed was measured with an HD2000 made by WYKO at 3.0 nm.

### Methods of Evaluating the Magnetic Heads

1. Obtaining Surface Topographic Image by Scanning Probe Microscope

The various heads were secured with suitable jigs. The surface of the AlTiC films sandwiching the insulating film in which the MR element was embedded was measured with the following device under the following conditions to obtain a surface topographic image (AFM topographic image) (subjected to collection for incline). The observation position was the center of the sliding surface of the tape and head.

Device: SPA500 scanning probe microscope made by Seiko Instruments (SII).
Measurement conditions: Micro cantilever OMCL-TR800 PSA-1 probe (made by Olympus)
Measurement mode: Contact mode
Observation area: 20 μm²
Scanning frequency: 1 Hz

2. Calculating the Average Area of the Indentations

The AFM topographic image taken by the scanning probe microscope that was obtained in 1. was subjected to correction for incline during measurement. The image processing software Scanning Probe Image Processor (SPIP: Image Metrology) was employed. By means of GrainDialog analysis with this software, the surface area distribution, standard deviation, and area ratio of the indentations were calculated. To determine the average depth of the indentations, the histogram data of the protrusion height obtained above were divided into peak 1 and peak 2 with the “Multgaussian function fitting” function of ORIGIN v7.5 software made by LightStone Corp. The value xt of the position of the tops of peak 1 and peak 2 was assumed to be such that xt1>xt2 (peak 1 was to the surface side).

y=y0+(A/(w*sqrt(PI/2)))*exp(−2*((x−xc)/w)̂2) Equation 1

[y: frequency, x: height, y0: baseline offset, A: total area between curve and baseline, x0: center of peak, w: about 0.849 of width at half of height of a/2 peak]

The difference in peak center values, x0(p1)−x0(p2) was calculated from the respective x0, w, and A values of peak 1 and peak 2 obtained from the fitting results acquired.

3. Measurement of Frictional Force

Two test pieces were cut from the magnetic tape fabricated in Example 1 and from each of the magnetic heads of the Examples and Comparative Examples so that they contained the tops of the protrusions. The frictional force was measured by bringing the tops of the protrusions into contact with the tape. The frictional force measuring device described in Japanese Unexamined Patent Publication (KOKAI) No. 2004-171723 was employed. The test pieces were positioned in pairs in the direction of width as frictional force measurement members contained in probes. The maximum static frictional force was calculated as the friction force in the direction of tape conveyance that was detected the instant movement began from a static state, and the dynamic frictional force was calculated as the frictional force in the direction of tape conveyance detected during tape running A maximum static frictional force of equal to or lower than 0.32 and a dynamic frictional force of equal to or lower than 0.21 were determined to permit stable running without the occurrence of stic-slip.

4. Measurement of Recording and Reproduction Characteristics

The various magnetic heads of the Examples and Comparative Examples were employed in a sliding contact linear tape drive to record and reproduce a single-frequency 200 kfci signal at a relative speed of 3 m/s on the magnetic tape fabricated in Example 1. The signal to noise ratio (SNR) was calculated from the ratio of the reproduction output (average value) to the integrated broadband noise (0 to 20 MHz, excluding noise in the vicinity (±0.5 MHz) of the carrier). The SNR is a parameter indicating the size of the output relative to the noise. The higher the value, the higher the quality of the signal reproduced. An SNR of equal to or higher than 16 dB can be determined to indicate good electromagnetic characteristics.

TABLE 1

| | | Standard | | | | | |
|---|---|---|---|---|---|---|---|
| | Average area | deviation of | Area ratio | | Maximum | | Recording and |
| | of | area of | of | Average depth | static | Dynamic | reproduction |
| | indentations | indentations | indentations | of indentations | frictional | frictional | characteristics |
| | (μm²) | (μm²) | (%) | (nm) | force | force | (SNR) |
| Ex. 1 | 0.2 | 1.3 | 30 | 20 | 0.30 (∘) | 0.18 (∘) | 16.9 dB |
| Ex. 2 | 1.0 | 1.3 | 30 | 20 | 0.25 (∘) | 0.19 (∘) | 17.5 dB |
| Ex. 3 | 0.6 | 0.5 | 30 | 20 | 0.31 (∘) | 0.17 (∘) | 17.0 dB |
| Ex. 4 | 0.6 | 2.0 | 30 | 20 | 0.27 (∘) | 0.18 (∘) | 16.9 dB |
| Ex. 5 | 0.6 | 1.3 | 20 | 20 | 0.28 (∘) | 0.16 (∘) | 16.6 dB |
| Ex. 6 | 0.6 | 1.3 | 50 | 20 | 0.24 (∘) | 0.19 (∘) | 16.8 dB |
| Ex. 7 | 0.6 | 1.3 | 30 | 15 | 0.30 (∘) | 0.18 (∘) | 16.2 dB |
| Ex. 8 | 0.6 | 1.3 | 30 | 50 | 0.25 (∘) | 0.17 (∘) | 17.1 dB |
| Comp. | 0.1 | 1.3 | 30 | 20 | 0.35 (x) | 0.24 (x) | 15.2 dB |
| Ex. 1 | | | | | | | |
| Comp. | 1.1 | 1.3 | 30 | 20 | 0.24 (∘) | 0.23 (x) | 15.8 dB |
| Ex. 2 | | | | | | | |
| Comp. | 0.6 | 0.4 | 30 | 20 | 0.33 (x) | 0.22 (x) | 15.6 dB |
| Ex. 3 | | | | | | | |
| Comp. | 0.6 | 2.1 | 30 | 20 | 0.26 (∘) | 0.24 (x) | 15.7 dB |
| Ex. 4 | | | | | | | |
| Comp. | 0.6 | 1.3 | 15 | 20 | 0.34 (x) | 0.22 (x) | 14.7 dB |
| Ex. 5 | | | | | | | |
| Comp. | 0.6 | 1.3 | 60 | 20 | 0.23 (∘) | 0.23 (x) | 15.4 dB |
| Ex. 6 | | | | | | | |
| Comp. | 0.6 | 1.3 | 30 | 14 | 0.33 (x) | 0.22 (x) | 15.9 dB |
| Ex. 7 | | | | | | | |

Evaluation Results

As shown in Table 1, the magnetic heads of Examples 1 to 8 achieved both running stability and good electromagnetic characteristics in combination with an extremely smooth magnetic tape.

The present invention can provide a magnetic signal recording and reproduction system that can handle even greater densities.

Although the present invention has been described in considerable detail with regard to certain versions thereof, other versions are possible, and alterations, permutations and equivalents of the version shown will become apparent to those skilled in the art upon a reading of the specification and study of the drawings. Also, the various features of the versions herein can be combined in various ways to provide additional versions of the present invention. Furthermore, certain terminology has been used for the purposes of descriptive clarity, and not to limit the present invention. Therefore, any appended claims should not be limited to the description of the preferred versions contained herein and should include all such alterations, permutations, and equivalents as fall within the true spirit and scope of the present invention.

Having now fully described this invention, it will be understood to those of ordinary skill in the art that the methods of the present invention can be carried out with a wide and equivalent range of conditions, formulations, and other parameters without departing from the scope of the invention or any embodiments thereof.

All patents and publications cited herein are hereby fully incorporated by reference in their entirety. The citation of any publication is for its disclosure prior to the filing date and should not be construed as an admission that such publication is prior art or that the present invention is not entitled to antedate such publication by virtue of prior invention.

What is claimed is:

1. A magnetic head employed in a linear tape drive, wherein
the linear tape drive is a sliding-contact linear tape drive in which a magnetic head comes in sliding contact with a magnetic tape during recording and/or reproduction of a magnetic signal,
the magnetic head comprises multiple indentations that are observed in a surface topographic image viewed by a scanning probe microscope on a surface of sliding contact with a magnetic tape, the surface being referred to as “sliding contact surface”, hereinafter, and
the multiple indentations satisfy (1) to (4) below:
(1) an average area of the indentations in the sliding contact surface ranges from about 0.2 μm² to about 1.0 μm²;
(2) a standard deviation of an area of the indentations ranges from about 0.5 μm² to about 2.0 μm²;
(3) an area ratio of the indentations in the sliding contact surface ranges from about 20 percent to about 50 percent; and
(4) an average depth of the indentations is equal to or greater than about 15 nm.

2. The magnetic head according to claim 1, which comprises two or more protrusions, each protrusion comprising a recording element and/or a reproduction element between a pair of ceramic films, and wherein the sliding contact surface is a top surface of the protrusion.

3. A linear tape drive apparatus comprising a magnetic tape and a magnetic head, wherein
the linear tape drive apparatus is a sliding-contact linear tape drive apparatus in which a magnetic head comes in sliding contact with a magnetic tape during recording and/or reproduction of a magnetic signal,
the magnetic head comprises multiple indentations that are observed in a surface topographic image viewed by a scanning probe microscope on a surface of sliding contact with a magnetic tape, the surface being referred to as “sliding contact surface”, hereinafter, and
the multiple indentations satisfy (1) to (4) below:
(1) an average area of the indentations in the sliding contact surface ranges from about 0.2 μm² to about 1.0 μm²;
(2) a standard deviation of an area of the indentations ranges from about 0.5 μm² to about 2.0 μm²;
(3) an area ratio of the indentations in the sliding contact surface ranges from about 20 percent to about 50 percent; and
(4) an average depth of the indentations is equal to or greater than about 15 nm.

4. The linear tape drive apparatus according to claim 3, wherein the magnetic head comprises two or more protrusions, each protrusion comprising a recording element and/or a reproduction element between a pair of ceramic films, and wherein the sliding contact surface is a top surface of the protrusion.

5. The linear tape drive apparatus according to claim 3, wherein the magnetic tape has a centerline average roughness ranging from about 0.1 nm to about 2.0 nm on a surface on which the magnetic tape comes in sliding contact with a magnetic head during the sliding contact.

6. A magnetic recording and reproduction method, wherein
a magnetic signal is linearly recorded and/or reproduced on a magnetic tape while a magnetic head comes in sliding contact with the magnetic tape,
the magnetic head comprises multiple indentations that are observed in a surface topographic image viewed by a scanning probe microscope on a surface of sliding contact with a magnetic tape, the surface being referred to as “sliding contact surface”, hereinafter, and
the multiple indentations satisfy (1) to (4) below:
(1) an average area of the indentations in the sliding contact surface ranges from about 0.2 μm² to about 1.0 μm²;
(2) a standard deviation of an area of the indentations ranges from about 0.5 μm² to about 2.0 μm²;
(3) an area ratio of the indentations in the sliding contact surface ranges from about 20 percent to about 50 percent; and
(4) an average depth of the indentations is equal to or greater than about 15 nm.

7. The magnetic recording and reproduction method according to claim 6, wherein the magnetic head comprises two or more protrusions, each protrusion comprising a recording element and/or a reproduction element between a pair of ceramic films, and wherein the sliding contact surface is a top surface of the protrusion.

8. The magnetic recording and reproduction method according to claim 6, wherein the magnetic tape has a centerline average roughness ranging from about 0.1 nm to about 2.0 nm on a surface on which the magnetic tape comes in sliding contact with a magnetic head during the sliding contact.

9. A method of manufacturing the magnetic head according to claim 1, comprising:
preparing a head chip comprising a recording element and/or a reproduction element between a pair of ceramic films; and
polishing a surface of the ceramic films to form the indentations.
